(19) United States
(12) Patent Application Publication
(10) Pub. No.: US 2005/0177816 A1
(43) Pub. Date: Aug. 11, 2005

(54) Automatic generation of graphical program code for a graphical program based on the target platform of the graphical program

(75) Inventors: Ramprasad Kudukoli, Austin, TX (US); Adam K. Gabbert, Austin, TX (US); Hugo A. Andrade, Austin, TX (US); Matthew E. Novacek, Austin, TX (US); Lukasz T. Darowski, Urbandale, IA (US)

Correspondence Address: MEYERTONS, HOOD, KIVLIN, KOWERT & GOETZEL, P.C., P.O. BOX 398, AUSTIN, TX, 78767-0398, US

(73) Assignee: National Instruments Corporation

(21) Appl. No.: 11/103,286

(22) Filed: Apr. 11, 2005

Related U.S. Application Data
(63) Continuation-in-part of application No. 10/094,198, filed on Mar. 8, 2002.
(60) Provisional application No. 60/560,859, filed on Apr. 9, 2004.

(51) Int. Cl. G06F 9/44; G06F 9/45; G06F 9/455

(52) U.S. Cl. 717/105; 717/109; 717/136; 716/11; 703/1

(57) ABSTRACT

A system and method for programmatically generating a graphical program in response to receiving input, e.g., user or process input. The input may specify functionality of the graphical program to be generated, and also indicate a target platform. In response to the input, a graphical program implementing the specified functionality may be programmatically generated for execution on the indicated target platform. Thus, different graphical programs, or different implementations of the graphical program, may be generated, depending on the input received. The graphical program (or implementation) may be at least partly optimized for execution on the indicated target platform. The graphical program may include a block diagram portion and a user interface portion, where the block diagram portion is specified for execution on the target platform, and the user interface portion is specified for execution on a computer system coupled to the target platform, e.g., for display of a user interface.

### CONTINUATION DATA

This application is a continuation-in-part of U.S. patent application Ser. No. 10/094,198, titled “Self-Determining Behavior Node for Use in Creating a Graphical Program” filed Mar. 8, 2002, whose inventors are Adam Gabbert, Steven W. Rogers, and Jeffrey L. Kodosky.

### PRIORITY DATA

This application claims benefit of priority of U.S. provisional application Ser. No. 60/560,859 titled “Automatic Generation of Graphical Program Code for a Graphical Program Based on the Target Platform of the Graphical Program” filed Apr. 9, 2004, whose inventors were Hugo A. Andrade, Matthew E. Novacek, Lukasz T. Darowski, Ramprasad Kudukoli, Adam Gabbert.

### FIELD OF THE INVENTION

The present invention relates to the field of graphical programming and to programmatically generating graphical programs, and more particularly to a system and method for automatically generating graphical program code for a graphical program based on the target platform of the graphical program.

### DESCRIPTION OF THE RELATED ART

Traditionally, high level text-based programming languages have been used by programmers in writing application programs. Many different high level text-based programming languages exist, including BASIC, C, C++, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various icons or nodes which represent desired functionality, and then connecting the nodes together to create the program. The nodes or icons may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

As graphical programming environments have matured and grown in popularity and complexity, it has become increasingly desirable to provide high-level tools which help a user create a graphical program. It also becomes increasingly desirable to integrate graphical programming environments with other applications and programming environments. In order to provide the desired tools or the desired integration, it would be greatly desirable to provide the ability to dynamically or programmatically generate a graphical program or a portion of a graphical program. For example, for various applications, it would be desirable to provide various types of program information to a program, wherein the program information specifies functionality of a graphical program (or portion of a graphical program) to be programmatically generated. For example, the program information may user specified and/or the result of (optionally programmatic) analysis of the graphical program.

As described above, a user typically creates a graphical program within a graphical programming environment by interactively or manually placing icons or nodes representing the desired blocks of functionality on a diagram, and connecting the icons/nodes together to represent one or more of the data flow, control flow, and/or execution flow of the program. The ability to programmatically generate a graphical program in response to program information would enable a graphical program or graphical program portion to automatically be generated without this type of interactive user input. For example, it would be desirable for the user to be able to specify program functionality at a high level via one or more graphical user interface (GUI) panels, and to then programmatically generate a graphical program or graphical program portion implementing the specified program functionality.

Graphical programs are currently being developed for various target platforms, such as FPGAs, embedded devices, and general purpose computer systems. In many cases, it would be desirable to at least partially customize or optimize a graphical program based on the target platform. It would further be desirable to at least partially customize or optimize a graphical program for different target platforms during programmatic or automatic creation of the graphical program.

### SUMMARY OF THE INVENTION

One embodiment of the present invention comprises a system and method for programmatically generating a graphical program or a portion of a graphical program, in response to receiving user input. The user input may specify functionality of the graphical program or graphical program portion to be generated. A graphical program generation program, referred to herein as a “GPG program”, may be executed, wherein the GPG program may be operable to receive the user input. The user input may comprise any type of information that specifies functionality of or aspects of the graphical program desired to be created. In response to the user input, the GPG program may programmatically generate a graphical program (or graphical program portion) that implements the specified functionality. Thus, the GPG program may generate different graphical programs, depending on the user input received.

In programmatically generating a graphical program, the GPG program may programmatically generate a block diagram portion comprising a plurality of connected icons or nodes, wherein the connected icons or nodes may visually or graphically indicate the functionality of the graphical program. The GPG program may also programmatically generate a user interface panel or front panel which may be used to provide input to and/or display output from the graphical program. For example, the GPG program may be constructed to programmatically generate one or more of a LabVIEW program, a VEE program, a Simulink program, etc.

The GPG program that generates the graphical program may be constructed using any of various programming languages, methodologies, or techniques. For example, the GPG program may itself be a graphical program, or the GPG program may be a text-based program, or the GPG program may be constructed using a combination of graphical and text-based programming environments.

Also, the GPG program may have any of various purposes or applications. In one embodiment, the GPG program may include or be associated with a program or application that directly aids the user in creating a graphical program. For example, the GPG program may be included in a graphical programming development environment application. In this case the graphical programming development environment application may be operable to receive user input specifying desired functionality and the GPG program may automatically, i.e., programmatically, add a portion of graphical program code implementing the specified functionality to the user's program. The user input may be received, for example, via one or more “wizard” graphical user interface (GUI) input panels or dialogs enabling the user to specify various options. Such graphical program code generation wizards may greatly simplify the user's task of implementing various operations. As an example, it is often difficult for developers of instrumentation applications to properly implement code to analyze an acquired signal, due to the inherent complexity involved. By enabling the developer to easily specify the desired functionality through a high-level user interface, the GPG program can receive this information and automatically create graphical code to implement the signal analysis. Furthermore, since the graphical code is generated programmatically, the code may be optimized, resulting in an efficient program and a readable block diagram without unnecessary code.

In various embodiments, an association between a generated graphical program and the received user input used in generating the graphical program may be maintained. For example, this association may enable the user to return from the programmatically generated graphical program (or portion) to the GUI input panel(s) originally used to specify the user input, e.g., in order to modify the programmatically generated graphical program (or portion). In one embodiment, a generated graphical program may be “locked”, requiring the user to explicitly unlock the graphical program before the graphical program can be modified.

In various embodiments, the GPG program may be operable to generate any of various types of graphical programs. For example, as discussed above, a generated graphical program may be targeted toward a particular graphical programming development environment application. The GPG program may thus utilize proprietary features or create files that are formatted in a manner expected by the graphical programming development environment. This may be desirable or necessary when the graphical programming development environment includes a runtime environment that is required for the created graphical program to execute. Examples of graphical programming development environments include LabVIEW, BridgeVIEW, DasyLab, and DiaDem from National Instruments, VEE from Hewlett Packard, Simulink from The MathWorks, Softwire from Measurement Computing, Inc., Sanscript from Northwoods Software, WiT from Coreco, and Vision Program Manager from PPT Vision, among others.

In various embodiments, the graphical program may be generated using any of various methods or techniques. Generating the graphical program may comprise generating one or more files or data structures defining the graphical program. When a user interactively develops a graphical program from within a graphical programming environment, the graphical programming environment may create one or more program files. For example, the program files may specify information such as a set of nodes that the graphical program uses, interconnections among these nodes, programmatic structures such as loops, etc. In other cases, the program files may store various data structures, e.g., in binary form, which the graphical programming environment uses to directly represent the graphical program. Thus, in programmatically generating the graphical program, the GPG program may programmatically generate one or more files or data structures representing the graphical program, wherein these files may be structured or formatted appropriately for a particular graphical programming environment.

In one embodiment, a graphical programming development environment may provide an application programming interface (API) which the GPG program can use to programmatically generate the graphical program. For example, for each node, user interface element, or other object of the graphical program, the API may be called to programmatically add the object to the graphical program, connect the object to other objects of the graphical program, etc. Thus, any necessary files or other constructs needed by the graphical programming environment in order to use the generated graphical program may be automatically created as a result of calling the API.

In one embodiment, programmatically generating the graphical program may comprise programmatically generating graphical source code for one or more I/O nodes, referred to as elemental I/O nodes, based on I/O resources of the target platform. For example, the user may include an (elemental) I/O node according to one embodiment of the present invention in the graphical program, where the I/O node may have a default functionality or, alternatively, may have no defined functionality. Once the I/O node has been included in the graphical program, the user may configure the node. For example, in one embodiment, the user may right click on the node to invoke display of configuration options, such as, for example, “bind to resource” and “show implementation” (or equivalents), among others. Selection of the first option may invoke or launch a binding tool whereby the user may provide input indicating a target platform and I/O resources (e.g., channels) of the platform, and whereby graphical source code may be bound to the I/O node based on the indicated target platform and I/O resources. Selection of the second option may invoke display of graphical program code scripted underneath the elemental I/O node (which may be useful for debugging). In one embodiment, the user may subsequently provide input indicating a different target platform and/or different I/O resources, invoking generation of different graphical program code for the I/O node in accordance with the modified platform/resources.

Thus, the graphical code underlying the I/O node may be “switched” out based on the indicated target platform, while the appearance of the node may remain unchanged.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to execute a graphical program according to an embodiment of the present invention;

FIG. 1B illustrates a network system comprising two or more computer systems that may implement an embodiment of the present invention;

FIG. 2A illustrates an instrumentation control system including various I/O interface options, according to one embodiment of the invention;

FIG. 2B illustrates an industrial automation system including various I/O interface options, according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 is a flowchart diagram illustrating one embodiment of a method for programmatically generating a graphical program in response to receiving program information;

FIG. 6 is a block diagram illustrating that a “GPG program” which programmatically generates a graphical program may be a program for any of various purposes and may receive information of any type to use in generating the graphical program;

FIG. 7 is a flowchart diagram illustrating one embodiment of a method for programmatically generating a graphical program in response to user input received via a graphical user interface;

FIG. 8 is a flowchart diagram illustrating one embodiment of a method for programmatically generating graphical source code associated with a particular node;

FIG. 9 illustrates an exemplary GUI input panel for configuring a waveform generator node;

FIGS. 10-15 show a simple example illustrating the concept of programmatically generating different graphical source code portions for a node in response to receiving user input for configuring the node;

FIG. 16 is a flowchart diagram illustrating one embodiment of a method for programmatically replacing graphical source code associated with a particular node;

FIGS. 17-22E illustrate an implementation of the present invention where underlying code for I/O nodes in a graphical program is programmatically generated based on the target platform for the program, according to one embodiment.

While the invention is susceptible to various modifications and alternative forms specific embodiments are shown by way of example in the drawings and are herein described in detail. It should be understood however, that drawings and detailed description thereto are not intended to limit the invention to the particular form disclosed, but on the contrary the invention is to cover all modifications, equivalents and alternative following within the spirit and scope of the present invention as defined by the appended claims.

### DETAILED DESCRIPTION OF THE PREFERRED EMBODIMENTS

Incorporation by Reference

The following references are hereby incorporated by reference in their entirety as though fully and completely set forth herein.

U.S. Provisional Application Ser. No. 60/560,859 titled “Automatic Generation of Graphical Program Code for a Graphical Program Based on the Target Platform of the Graphical Program” filed Apr. 9, 2004.

U.S. patent application Ser. No. 10/094,198, titled “Self-Determining Behavior Node for Use in Creating a Graphical Program” filed Mar. 8, 2002.

U.S. Pat. No. 5,481,741 titled “Method and Apparatus for Providing Attribute Nodes in a Graphical Data Flow Environment,” issued on Jan. 2, 1996.

U.S. Pat. No. 6,064,812 titled “System and Method for Developing Automation Clients Using a Graphical Data Flow Program,” issued on May 16, 2000.

U.S. Pat. No. 6,102,965 titled “System and Method for Providing Client/Server Access to Graphical Programs,” issued on Aug. 15, 2000.

U.S. patent application Ser. No. 09/136,123 titled “System and Method for Accessing Object Capabilities in a Graphical Program” filed Aug. 18, 1998.

U.S. patent application Ser. No. 09/518,492 titled “System and Method for Programmatically Creating a Graphical Program”, filed Mar. 3, 2000.

U.S. patent application Ser. No. 09/595,003 titled “System and Method for Automatically Generating a Graphical Program to Implement a Prototype,” filed Jun. 13, 2000.

U.S. patent application Ser. No. 09/745,023 titled “System and Method for Programmatically Generating a Graphical Program in Response to Program Information,” filed Dec. 20, 2000.

U.S. patent application Ser. No. 08/912,445 titled “Embedded Graphical Programming System” filed on Aug. 18, 1997, whose inventors were Jeffrey L. Kodosky, Darshan Shah, Samson DeKey, and Steve Rogers.

U.S. patent application Ser. No. 08/912,427 titled “System and Method for Converting Graphical Programs Into Hardware Implementations” filed on Aug. 18, 1997, whose inventors were Jeffrey L. Kodosky, Hugo Andrade, Brian Keith Odom, and Cary Paul Butler.

U.S. patent application Ser. No. 10/177,553 titled “Target Device-Specific Syntax and Semantic Analysis For a Graphical Program” filed on Jun. 21, 2002, whose inventors were Newton G. Petersen and Darshan K. Shah.

Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a communication medium such as a bus, network and/or a wireless link.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium, carrier medium, and/or programmable hardware element; encompasses various types of mediums that can either store program instructions/data structures or can be configured with a hardware configuration program.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW, DasyLab, DiaDem and Matrixx/SystemBuild from National Instruments, Simulink from the MathWorks, VEE from Agilent, WiT from Coreco, Vision Program Manager from PPT Vision, SoftWIRE from Measurement Computing, Sanscript from Northwoods Software, Khoros from Khoral Research, SnapMaster from HEM Data, Vis Sim from Visual Solutions, ObjectBench by SES (Scientific and Engineering Software), and VisiDAQ from Advantech, among others.

The term “graphical program” includes models or block diagrams created in graphical modeling environments, wherein the model or block diagram comprises interconnected nodes or icons that visually indicate operation of the model or block diagram; exemplary graphical modeling environments include Simulink, SystemBuild, Vis Sim, Hypersignal Block Diagram, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected nodes are often referred to as the block diagram portion of the graphical program.

Node—In the context of a graphical program, an element that may be included in a graphical program. A node may have an associated icon that represents the node in the graphical program, as well as underlying code or data that implements functionality of the node. Exemplary nodes include function nodes, terminal nodes, structure nodes, etc. Nodes may be connected together in a graphical program by connection icons or wires.

Data Flow Graphical Program (or Data Flow Diagram)—A graphical program or diagram comprising a plurality of interconnected nodes, wherein the connections between the nodes indicate that data produced by one node is used by another node.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

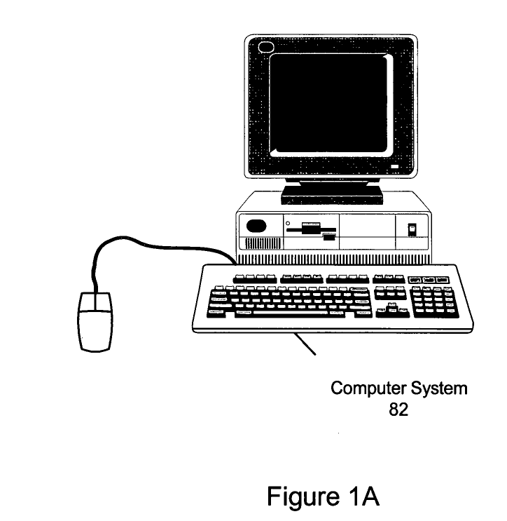

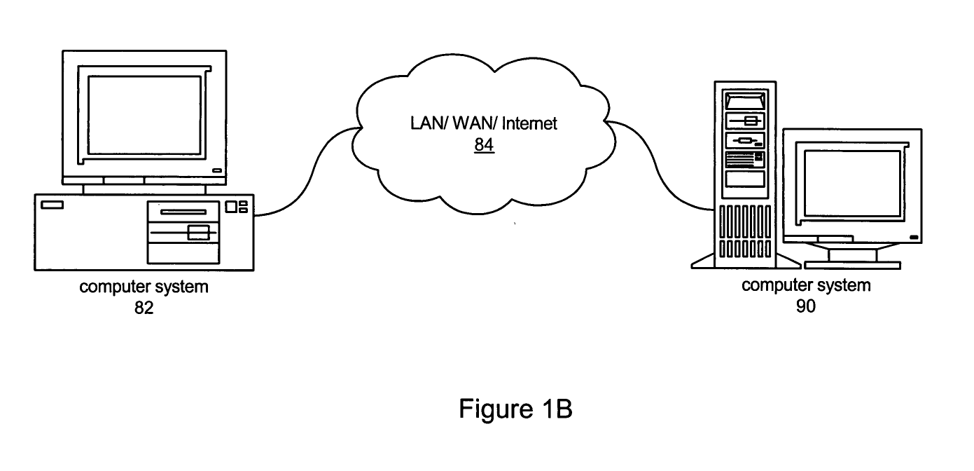

FIG. 1A—Computer System

FIG. 1A illustrates a computer system 82 operable to execute software configured to programmatically or automatically generate at least a portion of a graphical program based on a target platform for the graphical program. One embodiment of a method for creating a graphical program operable to generate at least a portion of a graphical program based on a target platform for the graphical program is described below.

As shown in FIG. 1A, the computer system 82 may include a display device operable to display the graphical program as the graphical program is created and/or executed. The display device may also be operable to display a graphical user interface or front panel of the graphical program during execution of the graphical program. The graphical user interface may comprise any type of graphical user interface, e.g., depending on the computing platform.

The computer system 82 may include a memory medium(s) on which one or more computer programs or software components according to one embodiment of the present invention may be stored. For example, the memory medium may store one or more graphical programs which are executable to perform the methods described herein. Also, the memory medium may store a graphical programming development environment application used to create and/or execute such graphical programs. The memory medium may also store operating system software, as well as other software for operation of the computer system. Various embodiments further include receiving or storing instructions and/or data implemented in accordance with the foregoing description upon a carrier medium.

The computer system 82 preferably includes or stores a computer program, referred to herein as a graphical program generation program, or a “GPG program”, that is operable to receive program information and programmatically generate a graphical program based on the program information. One embodiment of a method for programmatically generating a graphical program is described below.

In one embodiment, the GPG program may be implemented as a self-contained program or application that includes all necessary program logic for generating the graphical program. In another embodiment, the GPG program may comprise a client portion and a server portion (or client program and server program), wherein the client portion may request or direct the server portion to generate the graphical program. For example, the client portion may utilize an application programming interface (API) provided by the server portion in order to generate the graphical program. In other words, the client portion may perform calls to the API provided by the server portion, and the server portion may execute functions or routines bound to these calls to generate the graphical program. In one embodiment, the server portion may be an instance of a graphical programming development environment application. For example, the LabVIEW graphical programming development environment application enables client programs to interface with a LabVIEW server in order to programmatically generate or modify graphical programs.

As used herein, the term “GPG program” is intended to include any of various implementations of a program (or programs) that are executable to programmatically generate a graphical program based on received program information. For example, the term “GPG program” is intended to include an embodiment in which the GPG program is a self-contained program or application (not implemented as a client/server program) that includes all necessary program logic for programmatically generating a graphical program. The term “GPG program” is also intended to include an embodiment in which a combination of a client portion (or client program) and server portion (or server program) operate together to programmatically generate the graphical program. The term “GPG program” is also intended to include other program implementations.

In an embodiment in which a client program interfaces with a server program to generate the graphical program, the server program may execute on the same computer system as the client program or may execute on a different computer system, e.g., a different computer system connected via a network. For example, in FIG. 1B, the client program may execute on the computer system 82, and the server program may execute on the computer system 90. In this case, the graphical program, e.g., files representing the graphical program may be created on the computer system 82, or 90, or on a different computer system.

It is noted that the GPG program may be implemented using any of various programming technologies or methodologies. Where the GPG program is implemented as client and server programs, each of these programs may utilize procedure-based techniques, component-based techniques, and/or object-oriented techniques, among others. The programs may be written using any combination of text-based or graphical programming languages. Also, the programs may be written using distributed modules or components so that each program may reside on any combination of computer system 82, computer system 86, and other computer systems connected to the network 84. Also, in various embodiments, the client program may interface with the server program through a proxy software component or program.

FIG. 1B—Computer Network

FIG. 1B illustrates a system including a first computer system 82 that is coupled to a second computer system 90. The computer system 82 may be connected through a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device 190 connected to the computer system 82. The device 190 may include a programmable hardware element and/or may include a processor and memory medium which may execute a real time operating system. In one embodiment, the graphical program may be downloaded and executed on the device 190. For example, an application development environment with which the graphical program is associated may provide support for downloading a graphical program for execution on the device in a real time system.

Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

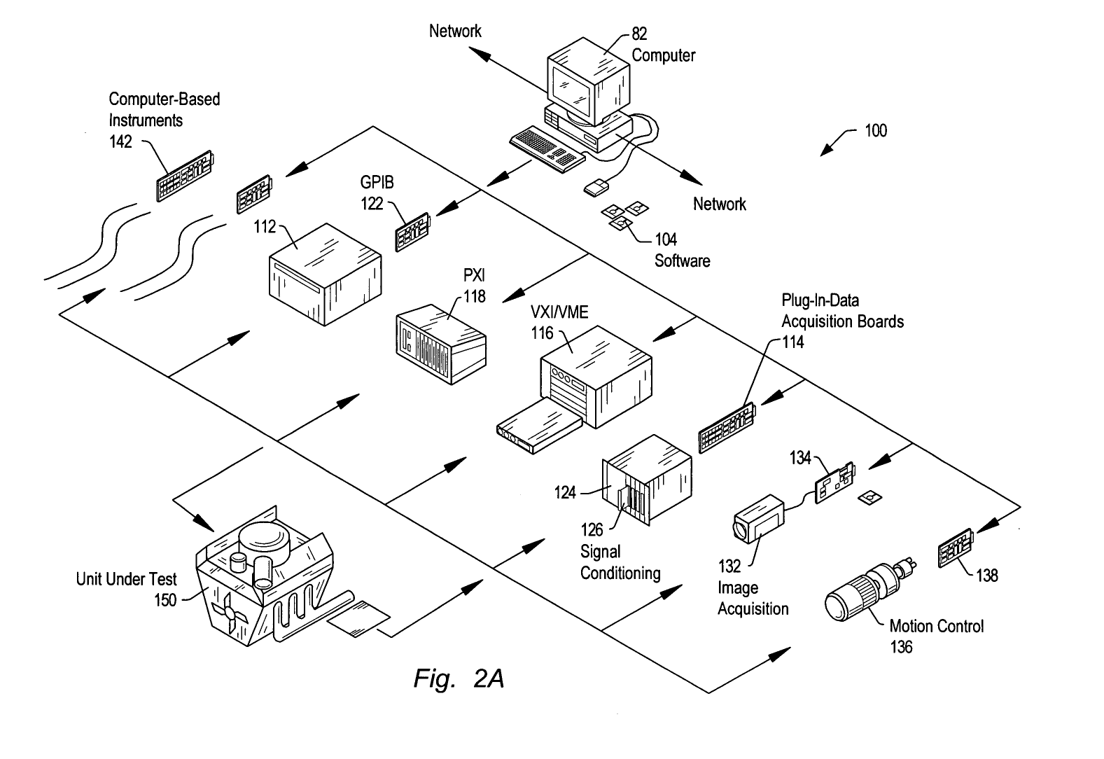

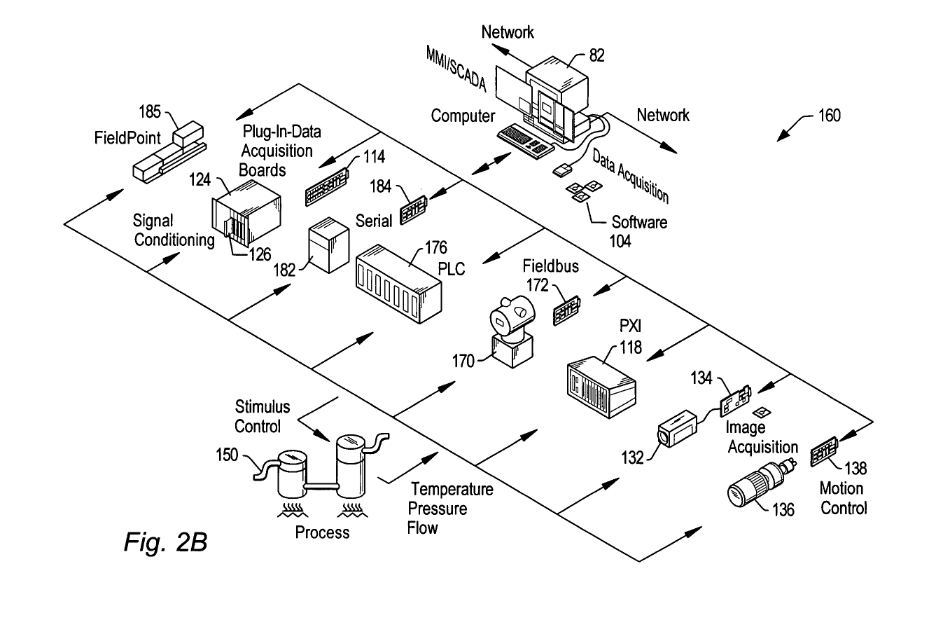

FIGS. 2A and 2B—Instrumentation and Industrial Automation Systems

FIGS. 2A and 2B illustrate exemplary systems which may store or use a GPG program and/or a server program which are operable to programmatically generate a graphical program. Also, these systems may execute a programmatically generated graphical program. For example, the graphical program may perform an instrumentation function, such as a test and measurement function or an industrial automation function. It is noted that the GPG program, the server program, and/or a generated graphical program may be stored in or used by any of various other types of systems as desired and may implement any function or application as desired. Thus, FIGS. 2A and 2B are exemplary only.

FIG. 2A illustrates an exemplary instrumentation control system 100 which may implement embodiments of the invention. The system 100 comprises a host computer 82 which connects to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which connects to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 and associated signal conditioning circuitry 124, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

In one embodiment, the GPG program and/or the resulting graphical program that is programmatically generated may be designed for data acquisition/generation, analysis, and/or display, and for controlling or modeling instrumentation or industrial automation hardware. For example, in one embodiment, the National Instruments LabVIEW graphical programming development environment application, which provides specialized support for developers of instrumentation applications, may act as the server program. In this embodiment, the client program may be a software program that receives and processes program information and invokes functionality of the LabVIEW graphical programming development environment. The client program may also be a program involved with instrumentation or data acquisition.

However, as noted above, the present invention can be used for a plethora of applications and is not limited to instrumentation or industrial automation applications. In other words, FIGS. 2A and 2B are exemplary only, and graphical programs for any of various types of purposes may be generated by a GPG program designed for any of various types of purposes, wherein the programs are stored in and execute on any of various types of systems. Various examples of GPG programs and generated graphical programs are discussed below.

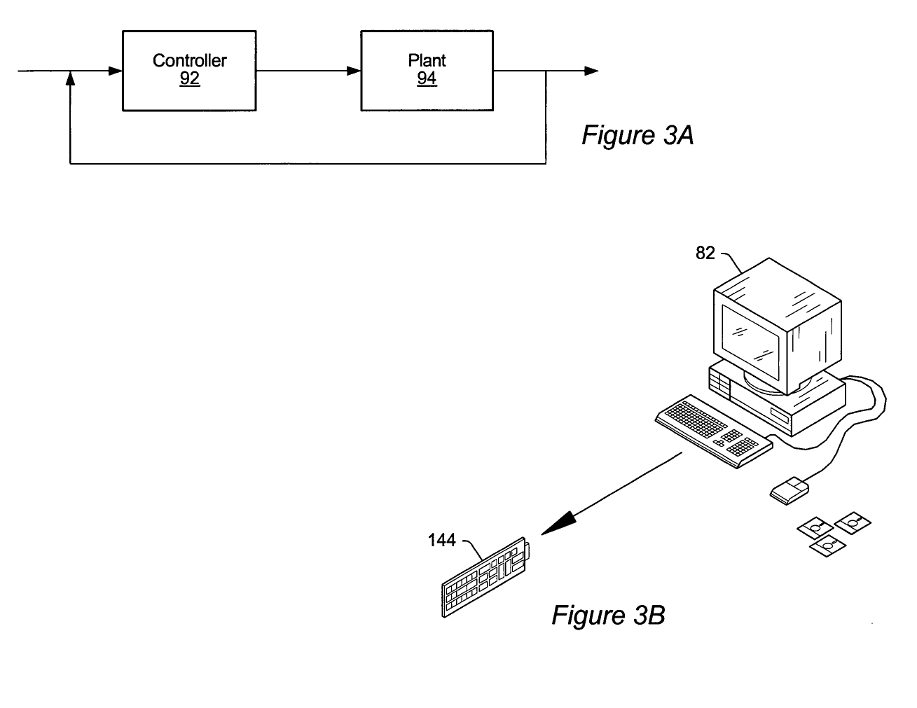

FIG. 3A is a high level block diagram of an exemplary system which may execute or utilize graphical programs. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical program, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

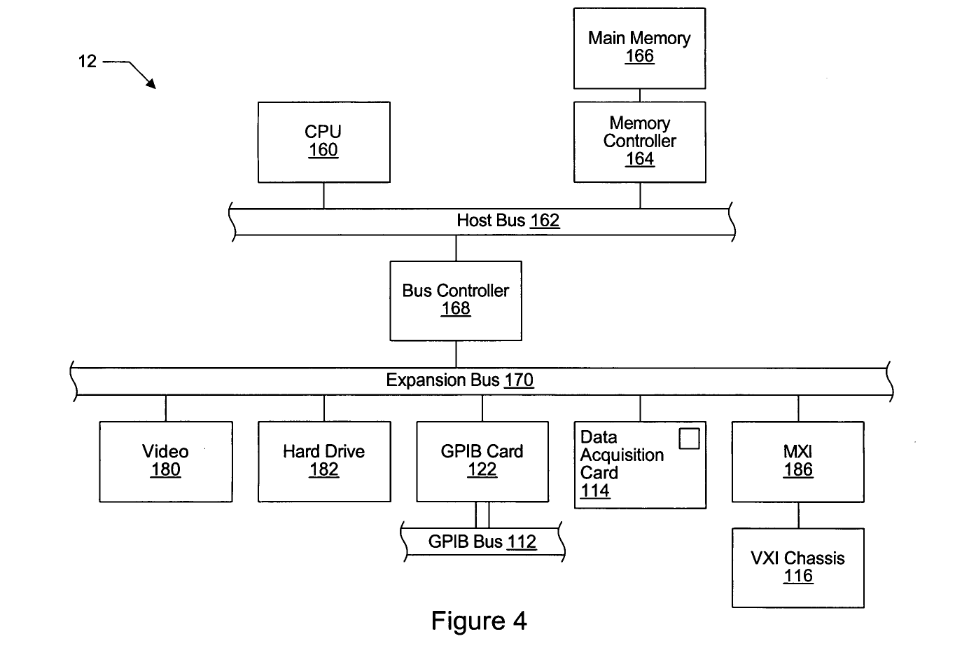

FIG. 4—Computer System Block Diagram

FIG. 4 is a block diagram representing one embodiment of the computer system 82 and/or 90 illustrated in FIGS. 1A and 1B, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the GPG program operable to programmatically or automatically generate at least a portion of a graphical program, e.g., graphical code, based on the target platform for the graphical program. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, a device 190 may also be connected to the computer. The device 190 may include a processor and memory which may execute a real time operating system. The device 190 may also or instead comprise a programmable hardware element. The computer system may be operable to deploy a graphical program to the device 190 for execution of the graphical program on the device 190. The deployed graphical program may take the form of graphical program instructions or data structures that directly represents the graphical program. In one embodiment, all or a portion of the deployed program may comprise a hardware configuration program, e.g., in a hardware description language (HDL) such as VHDL (very high speed integrated circuit hardware description language). For example, the graphical program may be converted to, or used to generate, the hardware configuration program. Alternatively, the deployed graphical program may take the form of text code (e.g., C code) generated from the graphical program. As another example, the deployed graphical program may take the form of compiled code generated from either the graphical program or from text code that in turn was generated from the graphical program.

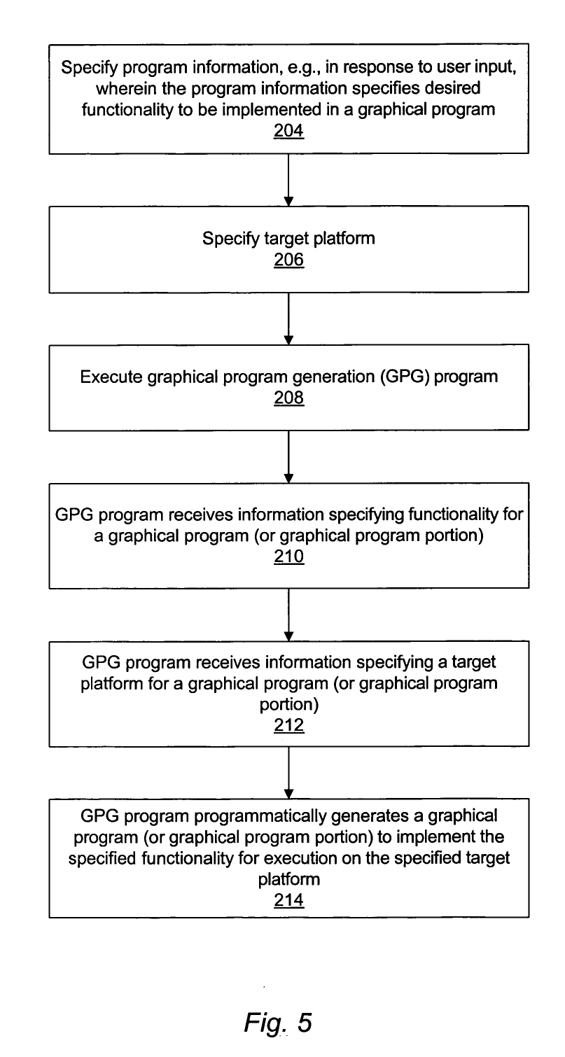

FIG. 5—Programmatic Creation of a Graphical Program

In prior systems, a user interactively or manually creates or edits a graphical program. For example, the user may interactively add various objects or icons to a graphical program block diagram, connect the objects together, etc. In contrast, one embodiment of the present invention comprises a system and method for programmatically generating a graphical program (or portion of a graphical program) without requiring this type of user interaction, where the graphical program is generated based on the target platform for the graphical program.

FIG. 5 is a flowchart diagram illustrating one embodiment of a method for programmatically generating a graphical program. In a preferred embodiment, a graphical program generation (GPG) program may perform all or a portion of the present method(s), wherein the GPG program is operable to programmatically generate a plurality of graphical programs, based on received information. As described below, the GPG program may be associated with any of various purposes or applications, and may be a standalone application, an integrated development environment, a plug-in to a development environment, part of a modular development system, and so forth. Also, as discussed above, the GPG program may be implemented in various ways, e.g., using graphical and/or text-based programming environments. For example, the GPG program may be a text-based program, such as a program written using C, C++, Java, Basic, Visual Basic, FORTRAN, Pascal, or another text-based programming language. Also, the GPG program may itself be a graphical program.

As described below, the GPG program may be implemented based on a client/server programming model. The client portion may call an application programming interface (API) provided by the server portion usable for programmatically creating the new graphical program. For example, a text-based GPG program may include text-based code for calling various API functions or methods, while a graphical GPG program may include various graphical nodes which are operable to invoke functions of the API. The creation of the GPG program may be performed by a developer, wherein the GPG program may then be used as a tool for the programmatic creation of graphical programs by users or other developers.

As shown in step 204, a graphical program (or graphical program portion) to be generated may be specified, e.g., in response to user input or input from a process. In other words, the input may specify or provide program information characterizing the graphical program. As described below, this program information may comprise any of various types of information and may specify functionality of the new graphical program. The program information may be based on an existing program, such as an existing graphical program, a state diagram, a timing diagram, or other program. The program information for the new graphical program may also be specified by the user through a graphical user interface (GUI). For example, the user may enter data or select various options specifying or indicating the program information. In one embodiment, the user may provide the program information by drawing a diagram in a window of the GUI. As described below in more detail, in one embodiment, the user may specify the graphical program to be generated via interaction with a wizard, where the wizard operates to lead the user through the specification process, e.g., via a series of dialogs or panels.

In step 206, information indicating a target platform for the graphical program may be specified, e.g., by input from a user or process, such as a “Plug and Play” process or other discovery process. For example, the user (or process) may specify a target platform type. Exemplary target platform types include general purpose computer system, e.g., a personal computer, workstation, mainframe, etc.; a programmable hardware element (e.g., FPGA); an embedded device; a grid computer, including wired and/or wireless distributed computers; a network computer; a PDA (Personal Digital Assistant); a tablet computer; a multi-purpose communication device, such as a cell phone with processing capabilities; a so-called ‘wearable computer’; a software emulation of a target device or system; a software simulation of a target device or system; etc.

In one embodiment, the target platform type may be characterized by operating system, e.g., Unix, Linux, Apple Computer's MacOS, Sun Microsystem's Solaris, Microsoft's Windows or Windows CE, and Palm Computing's Palm OS, among others. As is well known, different operating systems provide varying levels of support or infrastructure for different execution models or capabilities, such as, for example, multi-threaded execution, pipelining, parallel processing, etc., thus, specifying a target platform or target platform type may include specifying the platform hardware and/or the execution environment, i.e., the operating system or its equivalent.

In another embodiment, the target platform type may be characterized by desired attributes, requirements, and/or constraints on the platform. For example, the user may specify that the target platform is constrained to a particular CPU/memory configuration, e.g., a 1 MHz processor and 1 Mb RAM. As another example, the target platform may be required to include both a CPU and a programmable hardware element. As yet another example, the target platform may be required to include image acquisition capabilities, as well as an on-board processor and 512 Mb of RAM. Further examples of target platform characterizations include: a CPU running a real time operating system, e.g., LabVIEW RT; an FPGA with pipelining; and inclusion of an on-board digital signal processor (DSP), among others. Other aspects that may be used to characterize target platforms may include, for example, buffering capabilities, e.g., buffer size and/or performance, sample rates (which may be related to buffer resources), timed loops, display capabilities, e.g., a PDA vs. a PC with monitor, or even no display capabilities at all, and so forth.

In step 208, the GPG program may be executed. The GPG program may be executed in any type of computer system. Note that in various embodiments, the GPG program may be executed at different stages of the present method. For example, in an embodiment where the GPG is an integrated development environment, some or all of the previous steps, e.g., steps 204 and 206, may be performed by or in conjunction with the GPG program, and thus execution of the GPG program may be initiated prior to or as part of step 204 and/or step 206.

In step 210, the GPG program may receive the program information specifying the functionality for the graphical program or graphical program portion. As described below, the GPG program may receive any type of information from any type of source.

In step 212, the GPG program may receive the information indicating the target platform for the graphical program. For example, the information indicating the target platform may be received via a configuration tool (e.g., a wizard) or a GUI provided by the computer system executing the GPG program, or from another system over a network, e.g., the Internet. In an embodiment that uses a wizard to receive the information, the user may be queried for the information. In one embodiment, based on the specified functionality of the graphical program, the user may be presented with a list of appropriate target platforms or target platform types from which a selection may be made.

In an alternate embodiment, the target platform may be coupled to the computer system executing the GPG program, and the GPG (or another program executing on the computer system 82) may perform a discovery operation to determine the identity of and/or to characterize the target platform. For example, if the graphical program functionality is characterized as a measurement application, the GPG program may perform a discovery process to detect measurement hardware coupled to the computer system, and characterize the hardware, e.g., by querying the hardware itself (e.g., the target device), or a database. For example, the GPG program may access “Plug and Play” information indicating possible target devices coupled to the computer system 82. In one embodiment, the user may be prompted to confirm any characterization determined by discovery, and/or to provide additional guidance in characterizing the target platform.

In step 214, the GPG program may programmatically generate a graphical program or graphical program portion to implement the functionality specified by the received information. In other words, in response to receiving the information in step 208, the GPG program may programmatically generate a new graphical program or program portion based on the information. In a preferred embodiment, the GPG program may programmatically generate the graphical program or graphical program portion using or based on the indicated target platform for the graphical program. In other words, the graphical program may implement the specified functionality in various ways, and possibly to various degrees, depending on the indicated target platform, as described in more detail below.

The graphical program may be programmatically generated with little or no user input received during this creating. In one embodiment, the graphical program is programmatically generated with no user input required. In another embodiment, the user may be prompted for certain decisions during programmatic generation, such as the type of graphical program, the look and feel of a user interface for the graphical program, the number or degree of comments contained within the graphical program, etc.

In response to receiving the information in steps 210 and 212, the GPG program may process the information in order to determine how to generate the graphical program, i.e., in order to determine appropriate graphical source code for the program, an appropriate user interface for the program, etc. As described below, the determination of how to generate the graphical program may depend on a combination of the received information and/or the program logic of the GPG program (i.e., what the GPG program is operable to do with the received information).

Thus, where the target platform for the graphical program is a first target platform of a plurality of possible target platforms, the graphical program may be programmatically generated based on the first target platform. Similarly, where the target platform for the graphical program is a first type of a plurality of possible target platform types, the graphical program may be programmatically generated based on the first type of target platform. In other words, the graphical program may be programmatically generated differently for different target platforms. Said another way, an implementation of the graphical program may be generated based on the target platform for the graphical program, and thus, different implementations of the graphical program may be generated for different target platforms. For example, in one embodiment, the graphical program nodes included in the generated graphical program may be limited to those nodes that are supported by the indicated target platform, e.g., a graphical program aimed at a target platform that has no display capabilities may not include nodes related to displaying data, even if the inclusion of such nodes is otherwise specified.

In one embodiment, the programmatically generated graphical programs may be at least partly optimized for execution on the indicated target platforms. For example, the graphical program may be at least partly optimized with respect to one or more of: size of the graphical program, speed of execution of the graphical program, and parallelism of execution of the graphical program, among others.

As one example, where the input indicates that the target platform for the graphical program is a programmable hardware element (e.g., an FPGA), an implementation of the graphical program may be programmatically generated that is at least partly optimized for execution in the programmable hardware element. As another example, where the input indicates that the target platform for the graphical program is a processor executing a real time operating system, the programmatically generated graphical program may be at least partly optimized for execution by the processor executing the real time operating system. Similarly, where the input indicates that the target platform for the graphical program is a general purpose computer system, the generated graphical program may be at least partly optimized for execution by the general purpose computer system. Where the input indicates that the target platform for the graphical program is a grid computer comprising a plurality of networked computer systems (including wired and/or wireless networks), the generated graphical program may be at least partly optimized for execution by the grid computer in a distributed manner. Where the input indicates that the target platform for the graphical program is a person digital assistant (PDA), the generated graphical program may be at least partly optimized for execution by the PDA.

As yet another example, in an embodiment where the functionality includes measurement functionality, and where the input indicates that the target platform for the graphical program is a measurement device, the graphical program may be programmatically generated for execution on the measurement device. The graphical program may be at least partly optimized for one or more of: a sample rate of the measurement device, timing attributes of the measurement device, display capabilities of the measurement device, on-board signal processing resources of the measurement device, and number of channels supported by the measurement device.

Thus, as indicated above, in one embodiment, the method may include storing program information specifying desired functionality of the graphical program, receiving first input indicating a first target platform for the graphical program, and programmatically generating a first implementation of the graphical program in response to the program information and the first input, where the graphical program substantially implements the specified functionality, and where the first implementation of the graphical program is programmatically generated based on the first target platform for the graphical program.

In one embodiment, the method may further include receiving second input indicating a second target platform for the graphical program, and programmatically generating a second implementation of the graphical program in response to the program information and the second input, where the graphical program substantially implements the specified functionality, and where the second implementation of the graphical program is programmatically generated based on the second target platform for the graphical program.

Other embodiments are also contemplated where further input specifying further target platforms may be received, and respective further implementations of the graphical program may be programmatically generated based on the indicated further target platforms for the graphical program. In other words, in one embodiment, receiving input indicating a target platform for the graphical program includes receiving input indicating a plurality of target platforms for the graphical program, where the plurality of target platforms are indicated to conjunctively perform the functionality of the graphical program, and where programmatically generating the graphical program includes programmatically generating a corresponding plurality of portions of the graphical program for respective execution on the plurality of target devices.

In a preferred embodiment, the graphical program includes a plurality of interconnected nodes that visually indicate functionality of the graphical program. Thus, in programmatically generating different implementations of the graphical program for different target platforms, the different implementations of the graphical program may include one or more of: 1) different types of nodes in the graphical program; and 2) different interconnections of the nodes in the graphical program. For example, a first implementation of the graphical program may be programmatically generated which includes pipelining of nodes for a first type of target platform.

In one embodiment, the graphical program includes a block diagram and a user interface, where the block diagram includes a plurality of interconnected nodes, and where the user interface includes one or more graphical user interface elements for enabling user interaction with the block diagram. In this embodiment, programmatically generating the graphical program includes generating the block diagram portion and the user interface portion. Thus, in one embodiment, the programmatically generating is operable to generate different implementations of the block diagram for different target platforms. For example, the different implementations of the block diagram may include one or more of: 1) different types of nodes in the block diagram, and 2) different interconnections of the nodes in the block diagram.

Different implementations of the user interface may be programmatically generated for different target platforms. For example, in one embodiment, the programmatically generating may be operable to generate a first implementation of the graphical program which includes a reduced user interface for the graphical program for a first type of target platform, and to generate a second implementation of the graphical program which includes an enhanced user interface for the graphical program for a second type of target platform. In another embodiment, the programmatically generating may be operable to generate a first implementation of the graphical program which includes no interface for the graphical program for a first type of target platform, and to generate a second implementation of the graphical program which includes a user interface for the graphical program for a second type of target platform.

As another example, in an embodiment where the input indicates that the target platform for the graphical program is an embedded device with no inherent user interface capability, the programmatically generating may programmatically generate the graphical program having a block diagram implementation for execution on the embedded device and a user interface implementation for execution by a computer system including a display device, where the block diagram implementation executing on the embedded device is operable to communicate with the user interface implementation executing on the computer system.

Thus, depending on the characteristics of the indicated target platform, e.g., the display capabilities of the target platform, the user interface portion of the programmatically generated graphical program may include different levels (including none) of user interface functionality, or may implement various types or styles of user interface, or may be implemented for execution on devices other than the indicated target device (e.g., in conjunction with operation of the target device).

In generating the determined graphical program, the GPG program may specify the inclusion of various objects in the new graphical program. For example, as noted above, the new graphical program may have a diagram portion including a plurality of interconnected nodes which visually indicate functionality of the new graphical program. The new graphical program may also have a user interface portion including various user interface objects, such as one or more user interface panels having controls for specifying user input to the graphical program and/or indicators for displaying output from the graphical program. The GPG program may also specify other aspects of the graphical program, such as: interconnections between diagram objects, connections between diagram objects and user interface objects, numbers of objects, positions of objects, sizes of objects, input/output terminals or terminal names for diagram objects, comments for diagram objects, and properties or configuration of objects (e.g., configuration of data types, parameters, etc.), among other aspects of the graphical program.

Thus, depending on the capabilities or components of the indicated target device, one or more nodes may be omitted, modified, and/or included in the graphical program. For example, in an embodiment where the target platform for the graphical program is an embedded device with no inherent user interface capability, and where the embedded device is to operate independently, i.e., not in conjunction with another device having display capabilities, the graphical program may have a block diagram implementation for execution on the embedded device, but may omit nodes implementing a user interface, e.g., even if some user interface functionality were included in the specified functionality.

In various embodiments, the GPG program may generate a graphical program of any of various types. For example, the GPG program may generate the graphical program specifically so that a particular graphical programming development environment is operable to edit and/or execute the graphical program. In other embodiments, the GPG program may generate the graphical program so that two or more specific graphical programming development environments are operable to edit and/or execute a corresponding two or more portions of the graphical program, respectively.

In one embodiment, the GPG program may be a self-contained program that includes all executable logic necessary for programmatically generating the new graphical program. However, in the preferred embodiment, the GPG program utilizes a client/server programming model, in which the client portion processes the program information and determines the graphical program to be generated based on the program information (i.e., determines the function nodes or other objects to be included in the program, the interconnections among these nodes/objects, etc.) and the target platform(s) for the program. The client portion may then call an API provided by the server portion to request the server portion to perform the actual creation of the new graphical program, e.g., by creating files and/or other data structures representing the new graphical program. The server portion may execute on the same computer system as the client portion or may execute on a different computer system, e.g., a different computer system connected by a network. In one embodiment, the server portion may be an instance of a graphical programming development environment application, which provides an API enabling client programs to programmatically create and/or edit graphical programs.

The method of FIG. 5 is illustrated and is described above in terms of generating a new graphical program. It is noted that a similar method may be used to modify an existing graphical program, e.g., in order to add functionality to the program, such as functionality specified by user input received by a user interface wizard. In other words, instead of specifying creation of a new graphical program, the GPG program may specify the modification of an existing graphical program. When executed, the GPG program may then be operable to programmatically modify the existing graphical program. For example, the GPG program may include a reference to the existing graphical program and may perform various API calls to modify the graphical program based on the specified functionality desired and/or the specified target platform, e.g., by adding one or more objects to the graphical program, changing connections between graphical program objects, changing various properties of graphical program objects, etc. Thus, in one embodiment, the GPG may be used to port a program, or a portion of a program, to a particular target platform. In one embodiment, the existing program may be a text-based program, e.g., a C program, executable on a first target platform type, such as a personal computer running a Windows operating system. The GPG program may be operable to programmatically generate a graphical program targeted for execution on an embedded system, e.g., running LabVIEW RT. Thus, in some embodiments, the GPG program may operate as a program translator.

In yet another embodiment, the GPG program may itself be modifiable, e.g., in response to user input. For example, the user may invoke display of one or more dialogs, edit windows, palettes, or other editing means, e.g., within the graphical program development environment, to modify the GPG program. The modified GPG program may then be executable to generate the graphical program (or a subsequent version of a previously generated graphical program) in accordance with the modifications.

It is noted that FIG. 5 represents one embodiment of a method for programmatically generating a graphical program, and various steps may be added, reordered, combined, omitted, modified, etc. For example, as described above, the GPG program may include or may be associated with an application that the user uses to specify the program information. For example, such an application may enable the user to specify a state diagram, a test executive sequence, a prototype, etc., on which to base the graphical program. Thus, executing the GPG program in step 206 may comprise invoking a routine or program associated with this application, e.g., in response to the user selecting a menu option included in the application's user interface. In other embodiments, the user may launch the GPG program as an independent application.

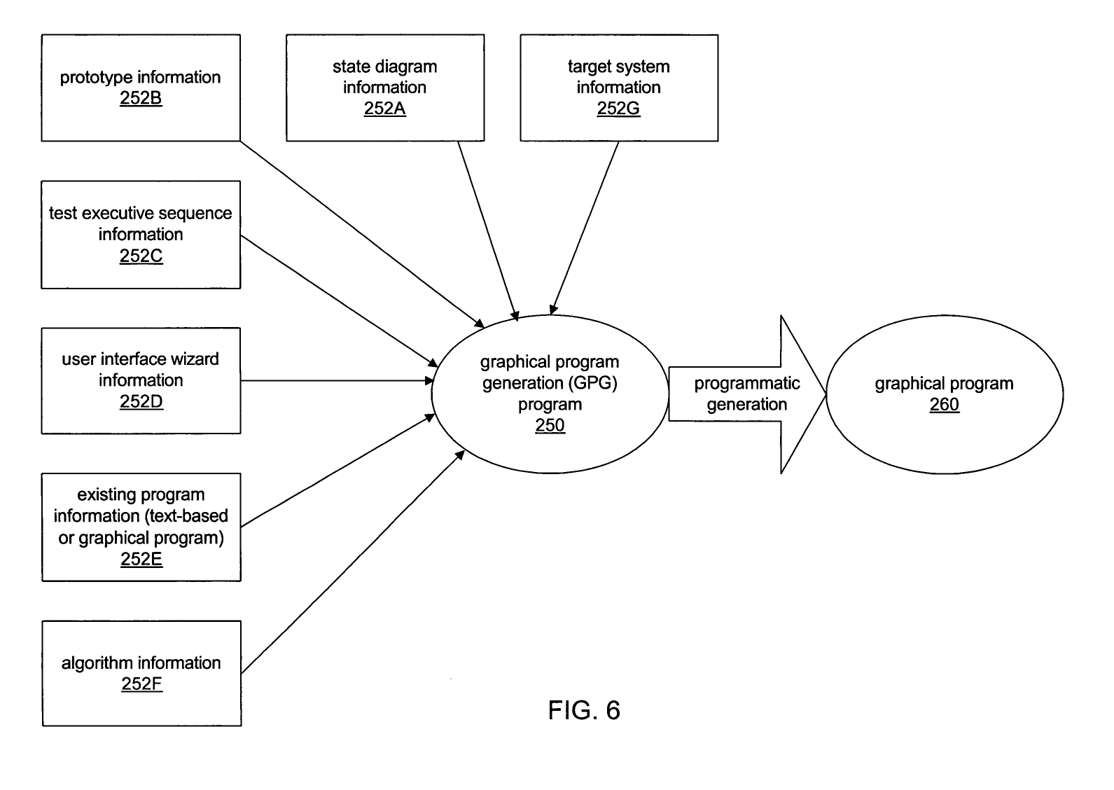

FIG. 6—Examples of GPG Programs and Received Information

FIG. 6 is a block diagram illustrating that the GPG program may be a program for any of various purposes and may receive information of any type to use in generating a graphical program. FIG. 6 illustrates a GPG program 250 and various types of program information 252 that the GPG program may receive.

In some embodiments, the GPG program 250 may include or be coupled with a program or application which a user utilizes to construct or characterize a computational process. In response to the specified computational process, the GPG program 250 may programmatically generate a graphical program to implement the computational process.

For example, a state diagram editor may be used to construct a state diagram characterizing a computational process, e.g., in response to user input. As shown in FIG. 6, the GPG program 250 may then receive state diagram information 252A and use this state diagram information to programmatically generate the graphical program. For example, the programmatically generated graphical program may implement functionality specified by the state diagram created by the user.

As another example, the GPG program 250 may include or be coupled with a program or application which a user utilizes to construct a prototype, e.g., in order to characterize an algorithm at a high level. The constructed prototype may be represented as prototype information 252B. In this case, the GPG program 250 may then programmatically generate a graphical program that implements the prototype, based on the prototype information 252B. For more information on programmatically generating a graphical program to implement a prototype, please see U.S. patent application Ser. No. 09/595,003, incorporated by reference above.

As another example, the GPG program 250 may include or be coupled with a program or application which a user utilizes to construct a test executive sequence, e.g., to perform a series of tests on a unit under test. In this case, the GPG program 250 may then programmatically generate a graphical program operable to perform the series of tests when executed, based on test executive sequence information 252C.

In other embodiments, the GPG program 250 may be associated with a program or application that directly aids the user in creating a graphical program. For example, the GPG program 250 may be associated with a graphical programming development environment application. In this case, the GPG program 250 may be operable to receive user input specifying desired functionality, indicated as user interface wizard information 252D in FIG. 6, and may automatically, i.e., programmatically, add a portion of graphical source code to the user's graphical program implementing the specified functionality. For example, the user interface wizard information 252D may be received via one or more “wizard” graphical user interface (GUI) panels or dialogs enabling the user to specify various options. Such graphical program code generation wizards may greatly simplify the user's task of implementing various operations. As an example, it is often difficult for developers of instrumentation applications to properly implement code to analyze an acquired signal, due to the inherent complexity involved. By enabling the developer to specify the desired functionality through a high-level user interface, the developer can quickly and easily request appropriate graphical source code for implementing the signal analysis to be automatically included in the graphical program. Furthermore, since the graphical source code is generated programmatically, the code may be optimized, resulting in an efficient program and a readable block diagram without unnecessary code.

In other embodiments, the GPG program 250 may be operable to automatically translate an existing program into a graphical program, as noted above with reference to FIG. 5. The GPG program may examine the existing program and programmatically generate a graphical program. In one embodiment, the GPG program may include or interface with different front-end plug-in modules, wherein each plug-in module is operable to analyze a particular type of program, e.g., a program written in a particular language or used by a particular development environment, and generate existing program information 252E usable by the GPG program for creating a graphical program that implements functionality of the existing program. The programmatically generated graphical program may perform the same, or substantially the same functionally as, or a subset of the functionality of the existing program.

In one embodiment, the existing program may be a text-based program, such as a C program. In another embodiment, the existing program may itself be a graphical program. For example, although graphical programs created using different graphical programming development environments are similar in some respects, the graphical programs typically cannot be easily transferred across different graphical programming environments for editing or execution. For example, different graphical programming development environments provide different nodes for inclusion in a block diagram, store program files in different formats, etc. Thus, if an existing graphical program associated with one programming environment is desired to be ported to a new programming environment, the GPG program may examine the existing graphical program (or may examine abstract information specifying the existing graphical program) and may programmatically generate a new graphical program associated with the new programming environment.

In another embodiment, the GPG program 250 may be operable to automatically generate a graphical program in response to algorithm information 252F.

In yet another embodiment, the GPG program 250 may be operable to automatically generate a graphical program in response to target system information 252G, including, for example, information indicating or characterizing one or more target platforms for execution of the generated program. In various embodiments, this target system information may be indicated or provided by the user, or may result from programmatic analysis, e.g., of program specifications, of the target system, and so forth.

In addition to the examples given above, a GPG program 250 may receive any other type of information and programmatically generate a graphical program based on the received information.

It is noted that, in various embodiments, the GPG program 250 may receive the information 252 used in generating the graphical program in any of various ways. The information may be received from the user, from another program, or from other sources, such as a file or database. The information may comprise information of any type, including text or binary information structured in any of various ways. The information may be self-describing, and/or the GPG program may include knowledge of how to interpret the information in order to generate the appropriate graphical program.

As an example, consider a state diagram editor application usable for constructing a state diagram. In this example, the GPG program may be or may be included in the state diagram editor application itself. For example, the state diagram editor application may receive input, e.g., user input, specifying state diagram information. The state diagram editor application may then programmatically generate a graphical program to implement functionality specified by the state diagram information, e.g., in response to the user selecting a menu option to generate the graphical program. In other embodiments, the GPG program may be separate from the state diagram editor application. For example, when the user selects the menu option to generate the graphical program, the state diagram editor application may provide the state diagram information to another application, i.e., the GPG program, which then generates the graphical program based on this information. In another embodiment, a user may invoke the GPG program separately and request the GPG program to generate a graphical program, e.g., by specifying a state diagram file. The GPG program may receive the state diagram information in any of various ways formats, e.g., as binary data, XML data, etc.

In most of the examples given above, functionality of the graphical program to be generated is specified explicitly by the received information. For example, a state diagram, user input specified via a wizard interface, a prototype, a test executive sequence, and an existing program, all explicitly specify, to varying degrees, functionality which the graphical program should implement.

It is noted that in other embodiments the received information by itself may not explicitly or inherently specify functionality of the graphical program to be generated. In a case such as this, the functionality of the generated graphical program may be determined mainly by the GPG program. Thus, one embodiment may include different “types” of GPG programs, wherein each type of GPG program is configured to generate graphical programs of a certain type. For example, consider two different GPG programs, program A and program B, which are both operable to receive numeric data from a database and create a graphical program based on the numeric data. Program A may be operable to create a graphical program which, when executed, performs one type of operation on the numeric data, and program B may be operable to create a graphical program which, when executed, performs a different type of operation on the numeric data. Thus, in these examples, the functionality of the graphical program is determined mainly by the GPG program that generates the graphical program.

Thus, in various embodiments, the functionality of the graphical program may be determined by the received program information, and/or the GPG program. In some cases the functionality may be specified almost entirely by the received information. For example, in a case where the GPG program programmatically translates an existing program to a new graphical program, the functionality of the new graphical program may be specified entirely by the existing program. In other cases, the received information and the GPG program may each determine a portion of the functionality. For example, in a case where the GPG program generates a graphical program to implement a test executive sequence, the test executive sequence information may determine the body of the program which includes the code for executing the tests, but the GPG program may be operable to add additional functionality to the graphical program, e.g., by adding code operable to prompt the user for a log file and save test results to the log file, code to display a user interface indicating the current unit under test and the current test being performed, etc.

In a typical case, the implementation of the source code for the graphical program is determined mainly or entirely by the GPG program, although the received information may influence the manner in which the GPG program generates the code, or the GPG program may receive separate information influencing the code generation. For example, consider a GPG program operable to translate an existing graphical program to a new graphical program, e.g., in order to port the existing graphical program to a new programming environment. In one embodiment, the GPG program may be operable to generate the new graphical program in such a way as to match the existing graphical program as closely as possible in appearance. In other words, the new graphical program may be generated so that when the user sees the block diagram of the new graphical program, the block diagram appears substantially the same as the block diagram of the existing graphical program, e.g., in terms of the number of block diagram nodes, the layout and interconnections among the block diagram nodes, etc. In another embodiment, the GPG program may be operable to implement the source code for the new graphical program differently, e.g., by optimizing the code where possible. In this example, the functionality of the generated graphical program may be the same in either case, but the graphical program may be implemented in different ways.

The GPG program may also receive input specifying how to implement the graphical program. For example, in the case above, the user may specify whether or not to perform optimizations when translating an existing graphical program. For example, the new programming environment may support downloading the generated graphical program to a hardware device for execution. If the user desires to download the generated graphical program to a hardware device, e.g., for use in a real-time application, then it may be important to optimize the new program. Otherwise, it may be more important to implement the generated graphical program similarly as the existing graphical program is implemented.

In one embodiment, the GPG program may provide extended support for specifying graphical program code implementation, beyond the ability to specify simple options. For example, the GPG program may support plug-ins specifying code generation information for various cases. Referring again to the program translation example above, each plug-in may specify how to generate code intended for execution on a particular hardware device. For example, if the generated program is to be run on an FPGA, the generation of the code may be optimized depending on the number of gates available on that particular FPGA.

In various embodiments, an association between a generated graphical program and the received program information used in generating the graphical program may be maintained. For example, after the graphical program has been generated, this association may enable a user to recall the program information or return to an application from which the program information originates, e.g., in order to view or edit the program information. For example, consider a prototyping environment application which enables a user to develop a prototype characterizing an algorithm. The prototyping environment application may programmatically generate a graphical program implementing the developed prototype. The user may then execute the graphical program, and if a problem with the program is discovered, the association may enable the user to return to the prototyping environment application in order to view or modify the prototype used to generate the program. The graphical program may then be programmatically modified or re-generated accordingly.

In one embodiment, a generated graphical program may be “locked”, requiring the user to explicitly unlock the program before the program can be modified within the graphical programming environment. Locking the graphical program may facilitate the retrieval or recreation of the program information that was used to generate the graphical program.

In various embodiments, the GPG program may be operable to generate any of various types of graphical programs. For example, as discussed above, a generated graphical program may be targeted toward a particular graphical programming development environment application, e.g., to utilize proprietary features or to create files that are formatted in a manner expected by the graphical programming development environment. Examples of graphical programming development environments include LabVIEW, BridgeVIEW, DasyLab, and DiaDem from National Instruments, VEE from Hewlett Packard, Simulink from The MathWorks, Softwire from Measurement Computing, Inc., Sanscript from Northwoods Software, WiT from Coreco, and Vision Program Manager from PPT Vision, among others.

In various embodiments, the graphical program may be generated using any of various methods or techniques. Generating the graphical program may comprise generating one or more files defining the graphical program. When a user interactively develops a graphical program from within a graphical programming environment, the graphical programming environment may create one or more program files. For example, the program files may specify information such as a set of nodes that the graphical program uses, interconnections among these nodes, programmatic structures such as loops, etc. In other cases, the program files may store various data structures, e.g., in binary form, which the graphical programming environment uses to directly represent the graphical program. Thus, in programmatically generating the graphical program, the GPG program may programmatically generate one or more files representing the graphical program, wherein these files are structured or formatted appropriately for a particular graphical programming environment.

In various cases, a graphical program generated by a GPG program in response to program information may be a fully working program. Thus, the user may load the generated graphical program into the graphical programming environment, execute the program, etc. In other cases, the generated graphical program may not be a complete program. As an example, if an existing program is translated to a graphical program, it may not be possible to translate the entire program. For example, the existing program may utilize functions which do not exist in the graphical programming environment to which the program is to be ported. However, the GPG program may still create a partial graphical program, making it relatively easy for the user to complete the graphical program. In still other cases, it may be desirable to programmatically generate only a graphical code portion, e.g., as discussed above in the case of user interface wizard tools that aid the user in program development.

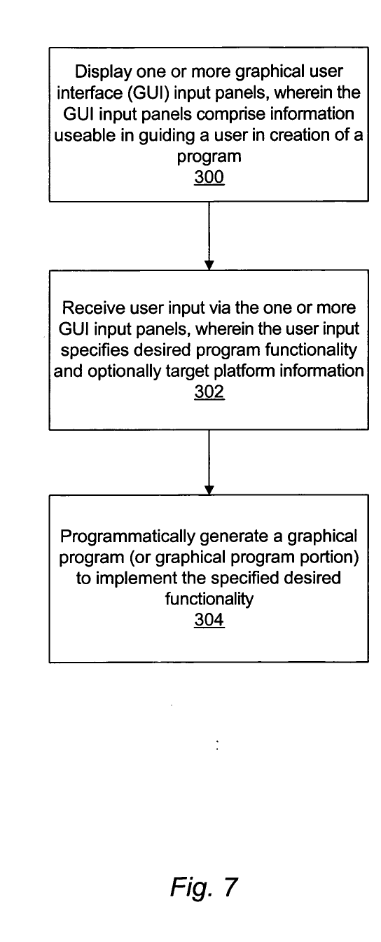

FIG. 7—Programmatically Generating a Graphical Program Portion in Response to User Input

As discussed above, in one embodiment, a graphical program or portion of a graphical program may be programmatically generated in response to program information received as input. FIG. 7 is a flowchart diagram illustrating one embodiment of a method for programmatically generating a graphical program in response to user input received via a graphical user interface (GUI). The GUI may be any type of GUI, and the user input may be received via the GUI in any of various ways. In one embodiment, the GUI may comprise one or more GUI input panels. The GUI input panels may take any of various forms, including a dialog box or window, and may include any of various means for receiving user input, such as menus, GUI input controls such as text boxes, check boxes, list controls, etc. The GUI input panels may comprise textual and/or graphical information and may be able to receive textual and/or graphical user input.

In step 300, the GUI may be displayed, e.g., one or more graphical user interface (GUI) input panels may be displayed, wherein the GUI input panels comprise information useable in guiding a user in creation of a program. For example, a GPG program may include various code generation “wizards”, i.e., tools that enable a user to specify desired program functionality at a high level via GUI input panels. The GUI input panels may be displayed in response to user input indicating a desire to specify program functionality. For example, the GPG program may provide various menu options for invoking the GUI input panels. As another example, the user may first display a node in a graphical program and may then request to configure functionality for the node, and GUI input panels for configuring functionality of the node may be displayed in response to this request. Exemplary GUI input panels are described below.

In step 302, user input may be received via the one or more GUI input panels, wherein the user input specifies desired program functionality. For example, as described above, the GUI input panels may comprise various GUI input controls such as text boxes, check boxes, list controls, etc., and the user may configure these GUI input controls to indicate the desired program functionality. As an example, consider a case where the GUI input panels enable the user to specify program functionality for generating waveform data. In this example, the GUI input panel may include a list GUI control for choosing whether to generate the data as a sine wave, square wave, etc., a numeric GUI control for specifying the desired amplitude for the wave, a numeric GUI control for specifying the desired frequency for the wave, etc. Thus, in this example, the user input received may specify the desired waveform type, the desired amplitude and frequency, etc. Additionally, in one embodiment, user input may be received specifying target system information, e.g., specifying one or more target platforms for the program, e.g., in terms of specific devices and/or in terms of broad types, e.g., categorized by operating system. Alternatively, the target system information may be received via other means, such as via a discovery process.

In step 304, a graphical program (or graphical program portion) to implement the specified desired functionality may be programmatically generated in response to the received user input. Step 304 may comprise programmatically including graphical source code in the graphical program. For example, the programmatically generated graphical source code may comprise a plurality of nodes that are interconnected in one or more of a data flow, control flow, and/or execution flow format, so as to implement the specified functionality. The nodes may have input/output terminals, terminal names, comments, or other aspects that are programmatically generated. Thus, the GPG program may be operable to generate various graphical programs (or portions), depending on the received user input. For example, in the waveform generation example discussed above, the GPG program may include a “sine wave” node in the graphical program if the user specifies to generate sine wave data in step 302 or may include a “square wave” node in the graphical program if the user specifies to generate square wave data. Additionally, in an embodiment where the target platform has been specified, the GPG program may generate the program specifically for execution on the specified target platform (or type of platform).

It is noted that in steps 300 and 302, a plurality of GUI input panels may be displayed, and user input may be received from each of these panels. For example, a first panel may be displayed on the display, wherein the first panel includes one or more first fields adapted to receive first user input specifying first functionality of the graphical program. User input specifying first functionality of the graphical program may be received via the first panel. A second panel may then be displayed for receiving second user input specifying second functionality of the graphical program. In one embodiment, the second panel that is displayed may be based on the first user input. In other words, in one embodiment the GUI input panels may be displayed in a wizard-based manner that guides the user in specifying the desired functionality and/or the target platform.

It should be noted that while the method presented in FIG. 7 generates the graphical program in response to user input, in other embodiments, the input specifying the functionality may be provided via other means, such as another program, a discovery process, a database, etc. For example, in some embodiments, instead of, or in addition to, user input specifying functionality of the graphical program, the generated code may be created based on the code coupled or connected to the node. In other words, the program context of a node in the graphical program may at least in part determine the functionality of the node, i.e., may determine at least a portion of the generated code. Said another way, generated code for a node may be determined based on one or more nodes surrounding, or coupled to, the node in the graphical program. Thus, for example, if the node were connected to an analog waveform node, the generated code may be directed to analog waveforms.

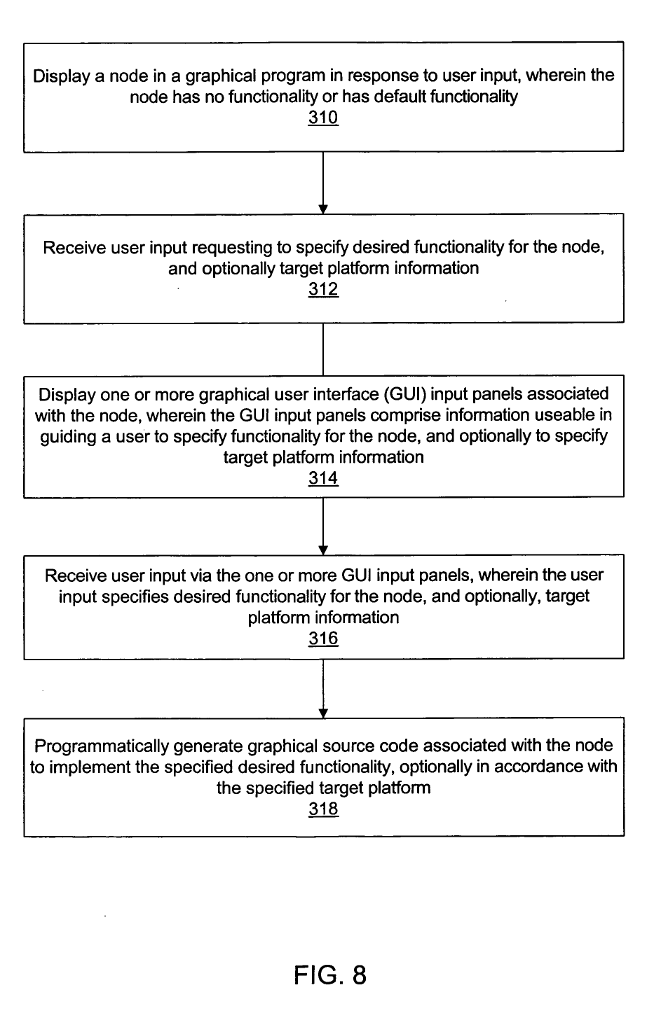

FIG. 8—Programmatically Generating Graphical Source Code for a Node

FIG. 8 is a flowchart diagram illustrating one embodiment of a method for programmatically generating graphical source code associated with a particular node. The flowchart of FIG. 8 illustrates one embodiment of the method of FIG. 7, in which a graphical program portion is programmatically generated in response to user input.

In step 310, a node may be displayed in a graphical program, wherein the node initially has no functionality or has default functionality. As described below, the node may be able to take on different functionality in the graphical program, depending on configuration user input received. The node may be generally related to a particular functional realm, such as data acquisition, signal analysis, data display, network communications, etc. However, until configuration user input is received for the node, as described below, the exact behavior of the node within the graphical program may be undefined.

In step 312, user input requesting to specify desired functionality or configuration information for the node may be received. For example, the user may double click on the node, execute a menu option for configuring the node, or perform this request in any of various other ways. Note that in one embodiment, the configuration information for the node may include target system information, e.g., one or more target devices or a types of target devices on which the node is to execute.

In step 314, one or more GUI input panels associated with the node may be displayed in response to the user request received in step 312, wherein the GUI input panels comprise information useable in guiding the user to specify functionality for the node. In step 316, user input specifying desired functionality for the node may be received via the one or more GUI input panels. In other words, the node may be configured to perform a variety of functions within the program, depending on this received user input. As noted above, the node may be generally related to a particular functional realm, such as data acquisition, signal analysis, data display, etc. Thus, the GUI input panels displayed may comprise information related to the particular functional realm. For example, for a node related to network communications, the GUI input panel may comprise GUI controls for configuring the node to specify a data source or target to which to connect, specify a connection protocol, etc. Additionally, in one embodiment, one or more target platforms may also be specified for the program, as described above, where the specified target platform may be a specific device, or may be a type of device, e.g., a broad type or class of device, e.g., devices operating under a particular operating system.

In step 318, graphical source code may be programmatically generated based on the desired functionality specified in step 316. This graphical source code may be associated with the node in the graphical program, such that the node is operable to implement the desired functionality specified in step 316 when the graphical program is executed. The programmatically generated graphical source code may comprise graphical source code similar to that which a user could create manually in a graphical programming development environment, e.g., by including various function nodes or other types of nodes in the graphical program and connecting the nodes in one or more of a data flow, control flow, and/or execution flow format. In embodiments where the target platform is specified, the graphical source code may be programmatically generated in accordance with the specified target platform. Thus, one or more of the nodes included in the program, or the functionality (code) underlying the nodes, may be specific to the specified target platform.

The programmatically generated graphical source code may be associated with the node in various ways. In one embodiment, the graphical source code programmatically generated for the node may replace the node in the graphical program so that the node is no longer visible in the graphical program. However, in the preferred embodiment, the graphical program may still appear the same, even after the graphical source code has been programmatically generated in association with the node. That is, in response to the user input specifying desired functionality for the node, the graphical source code implementing the specified functionality may be generated “behind” the node in a hierarchical fashion, such that the node still appears in the graphical program. In this instance, the graphical source code may be programmatically created as a sub-program (or “sub-VI”) of the graphical program, wherein the node represents the sub-program. Generating the portion of graphical source code behind the node in this way may help to keep the graphical program more readable.

The user may choose to view the graphical source code programmatically generated behind the node if desired. For example, in response to using a menu option or double-clicking on the node to view the source code generated behind the node, the programmatically generated graphical source code may be displayed. This may enable the user to modify the programmatically generated source code if desired. However, in one embodiment, the user may be prevented from viewing and/or editing the programmatically generated graphical source code. For example, for a Lite or Express version of a graphical programming development environment product, it may be desirable to prevent users from viewing the programmatically generated graphical source code. This may force the user to control the functionality of the node through the GUI input panel(s) for the node rather than directly modifying the graphical source code. For example, this may help to prevent novice users from becoming confused by seeing more complex graphical source code.

As noted above, in one embodiment, when the node is initially displayed in the program, the node may have no functionality. That is, the node may not initially be operable to perform any function when the graphical program is executed. A traditional function node available for inclusion in a graphical program typically has associated program instructions that are executed when the node is executed in the program. In this case, however, the node displayed in step 310 may not initially have such associated program instructions. Instead, the programmatically generated graphical source code that is associated with the node in step 318 may define the program instructions to be executed for the node. For example, these program instructions may be created from the programmatically generated graphical source code when the graphical program is compiled or interpreted, and these program instructions may be executed when the node is executed in the program.

Also as noted above, in one embodiment, when the node is initially displayed in the program, the node may have default functionality. That is, the node may initially be operable to perform a default function when the graphical program is executed. Thus, the node may have associated program instructions to be executed when the node is executed in the program, or there may be default graphical source code associated with the node when the node is initially included in the graphical program. In this case, the programmatically generated graphical source code that is associated with the node in step 318 may replace the default functionality for the node.

In embodiments where a target platform is specified for execution of the node or program, the source code underlying the node may be replaced, augmented, or otherwise modified for proper execution on the specified target platform.

As described above, a node may be configured to perform a plurality of operations, depending on user input specifying configuration information for the node. The configuration information may be received via one or more GUI input panels and may specify one or more desired operations for the node from the plurality of possible operations. However, since the graphical source code associated with the node is generated programmatically, a “minimal” amount of graphical source code may be generated, i.e., only graphical source code necessary to implement the one or more desired operations may be generated. Thus, source code corresponding to operations from the plurality of operations that are not among the one or more desired operations may not be included in the graphical program.

Associating a minimal amount of source code with a graphical program node operable to perform a plurality of operations may have several advantages. For example, by only including graphical source code in the program that is actually used, the program may be significantly more readable. Also, by not including unnecessary code the size of the program can be reduced, which may be important for systems with limited amounts of memory. Also, if the program is to be implemented in a hardware device, e.g., in an FPGA device, then it may be especially important to reduce the program size so that the program may be implemented with a limited amount of hardware resources available on the device.

It should be noted that in various embodiments, the program instructions that actually generate the graphical source code for the node may reside in different places or be executed by different portions of the system. For example, in a preferred embodiment, the node itself may include this functionality. In other words, in addition to any default program functionality the node may (or may not) have, the node may include program instructions that execute to perform the programmatic code generation described above, thereby generating graphical program code for itself. Alternatively, the program instructions that generate the graphical source code for the node may be part of the development environment, and thus may be invoked and executed by the environment. In one embodiment, the code generation may be performed by a software tool or plugin that operates in conjunction with the development environment.

It should be noted that while the method presented in FIG. 8 generates the graphical source code for a node in response to user input, in other embodiments, the input may be provided via other means, such as another program, a discovery process, a database, etc., as mentioned above.

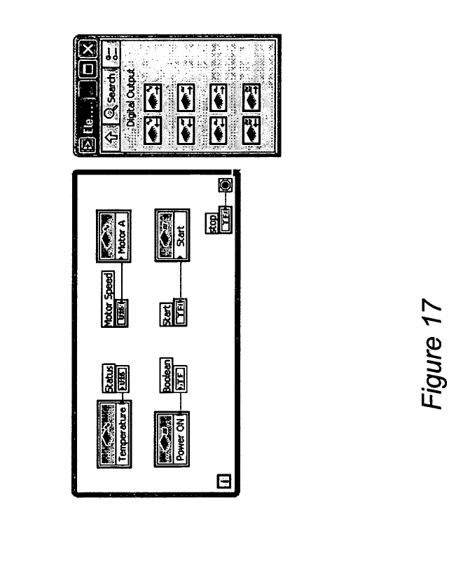

A detailed implementation of one embodiment of the invention where node functionality is implemented programmatically based on target platform is described below with reference to FIGS. 17-22E.

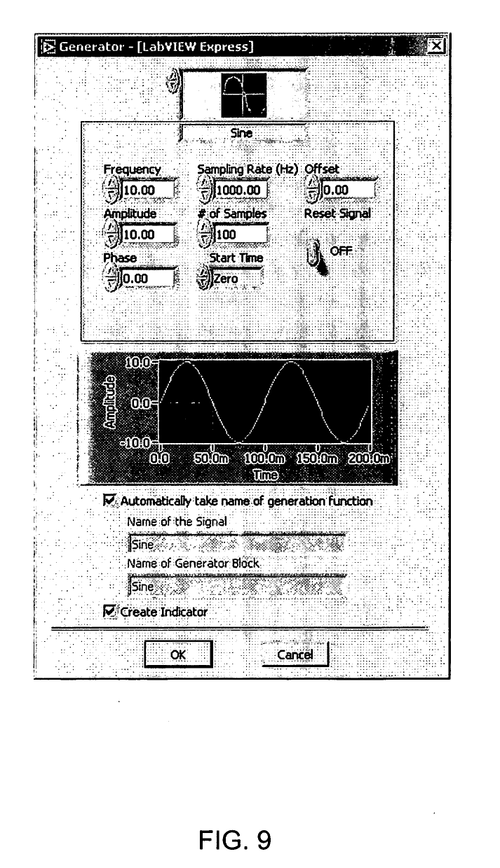

FIGS. 9-15: Examples

As described above with reference to FIG. 8, in one embodiment, the user may first display a node in a graphical program and may then utilize one or more GUI input panels to configure program functionality for the node. FIG. 9 illustrates an exemplary GUI input panel for configuring a waveform generator node. In response to the user specifying different settings for the GUI controls on the GUI input panel, different graphical source code portions may be programmatically generated for the waveform generator node.

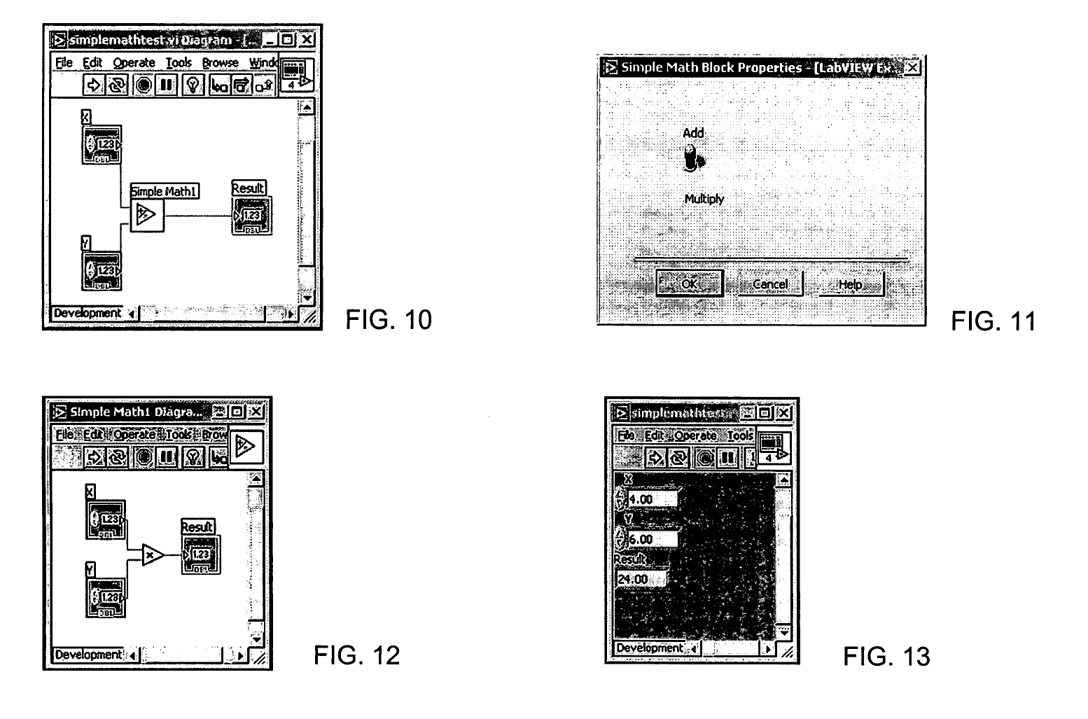

FIGS. 10-15 show a simple example illustrating this concept. FIG. 10 illustrates a graphical program including a “Simple Math” node. FIG. 11 illustrates a GUI input panel for configuring functionality of the Simple Math node. For example, a user may double-click on the Simple Math node or may execute a menu option to display the GUI input panel of FIG. 11. As shown, the user may choose to configure the Simple Math node to perform either an add or a multiply operation.

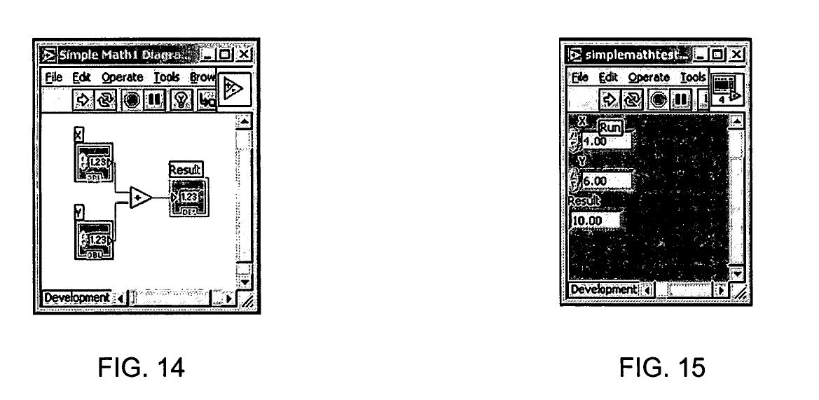

In response to the user input received via the GUI input panel of FIG. 11, different portions of graphical source code may be programmatically generated in the graphical program. If the user chooses the multiply operation, then the graphical source code of FIG. 12 may be programmatically generated, this portion of graphical source code includes a multiplication function node. If the user chooses the add operation, then the graphical source code of FIG. 14 may be programmatically generated, this portion of graphical source code includes an addition function node. FIGS. 13 and 15 illustrate GUI panels for the graphical program that indicate the execution results of the graphical source code of FIGS. 12 and 14, respectively.

The graphical source code of FIG. 12 illustrates a multiplication node, and the graphical source code of FIG. 14 illustrates an addition node. When the user first includes the Simple Math node in the graphical program, the Simple Math node may not be associated with either one of the multiplication or addition node, or may be associated with a default one of these nodes. In response to the user operating the GUI input panel of FIG. 11, the GPG program (which in this example may be a graphical programming development environment application) may programmatically generate either the multiplication or addition node such that the programmatically generated node is associated with the Simple Math node and in effect replaces the Simple Math node during program execution. However, as described above, the program may still appear to the user as shown in FIG. 10, in which the Simple Math node is shown. That is, the multiplication or addition node may be generated “behind” the Simple Math node. The user may then request to view the graphical source code generated behind the Simple Math node if desired.

FIGS. 10-15 show a very simple example of an operation of configuring program functionality for a node, and it is noted that more complex GUI input panels may be used to create more complex graphical source code portions. Additionally, as described above, in some embodiments, target system information may be taken into account in the programmatic creation of the source code or source code portions.

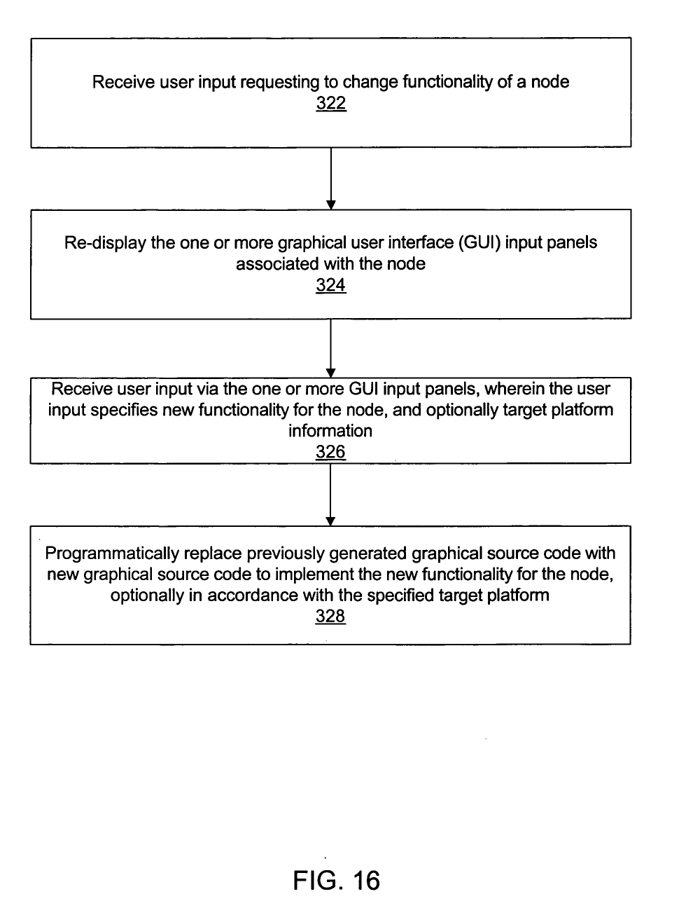

FIG. 16—Programmatically Replacing Graphical Source Code for a Node

FIG. 16 is a flowchart diagram illustrating one embodiment of a method for programmatically replacing graphical source code associated with a particular node. As described above with reference to FIG. 8, graphical source code defining functionality for a node may be programmatically generated and associated with the node in response to user input. FIG. 16 illustrates one embodiment of a method for changing the functionality of the node.

In step 322, user input requesting to change functionality of the node, and/or optionally to change target platform for the node, may be received. For example, this input may be received similarly as in step 312 of FIG. 8, e.g., by the user double-clicking on the node, executing a menu option for configuring the node, etc.

In step 324, the one or more GUI input panels associated with the node displayed in step 314 may be re-displayed in response to the user request received in step 322. As described above, the GUI input panel(s) may comprise information useable in guiding the user to specify functionality for the node. In this case, the GUI input panels may be used to specify additional or changed functionality for the node. In some embodiments, one or more GUI input panels may also be used to specify a target platform for the node.

In step 326, user input specifying new functionality for the node may be received via the one or more GUI input panels. For example, referring again to the waveform generator node example discussed above, if the node was originally configured to generate sine wave data, the GUI input panel(s) may be used to reconfigure the node to generate square wave data. As noted above, in some embodiment, user input specifying a target platform for the node may also be received via the one or more GUI input panels. As also noted above, in other embodiments, the target platform may be specified via other means, e.g., via a discovery process, from a configuration file, and so forth.

In step 328, the graphical source code that was previously generated in association with the node may be replaced with new graphical source code that implements the specified new functionality for the node or may be modified to implement the specified new functionality. In embodiments where a target platform is specified, the new or modified graphical source code may be targeted for execution on the specified target platform.

It is noted that although the method of FIG. 16 is discussed in terms of replacing graphical source code generated in association with a particular node, a similar method may be employed to replace a graphical program portion generated in accordance with the more general case of the method of FIG. 7.

FIGS. 17-22E—An Exemplary Implementation of Programmatic Generation

Generally, target platforms include an execution platform and an I/O (input/output) device. Both the execution platform and the I/O device may include hardware and some form of operating software, drivers, or protocol. As one example, a real time (RT) target platform may comprise a PXI-8176 controller running LabVIEW RT, provided by National Instruments Corporation, and the I/O device may comprise one or more DAQ cards coupled to the controller, and operable to acquire data and provide the data to the controller. As noted above, other target platforms may include PDAs, FPGAs, computers running different operating systems, etc.

Often, core application program code, e.g., LabVIEW graphical source code, may be written such that it may run on many different supported targets. However, program code relating to I/O is typically specific to the hardware being used, and so may need to be written (or rewritten) for different targets. For example, a graphical program or VI targeted for execution on an FPGA that uses native I/O nodes may not be easily ported to an MPC565 embedded microcontroller because the I/O driver code is substantially different.

FIGS. 17-22E illustrate one embodiment of an implementation of the present invention where the underlying code for I/O nodes in a graphical program may be programmatically generated based on the target platform for the program. These nodes may be referred to as elemental I/O, and may facilitate switching between targets without rewriting I/O code.

In one embodiment, elemental I/O nodes may comprise statically configured single point I/O, which may be particularly suitable for embedded applications. In a preferred embodiment, elemental I/O nodes may be used as basic building blocks for more complex I/O types.

It should be noted that since elemental I/O nodes may abstract statically configured single point I/O, the graphical program or block diagram representation of the nodes (e.g., the node icons) may remain the same across multiple targets that support them. Based on static configuration information, e.g., supplied by the user via dialogs, the elemental I/O nodes or process associated with the nodes may script the correct code in its place during editing of the block diagram. This process may be loosely analogous to the use of reconfigurable macros in text-based languages. For example, macro definitions may be stored in special files managed by the development environment, e.g., an “Elemental I/O Workspace”.

In one embodiment, the implementation of elemental I/O may include one or more tools facilitating the use of elemental I/O nodes, such as, for example, a configuration dialog, an embedded project manager, a property builder utility, and/or a plugin wizard, among others. These tools are described in more detail below. It should be noted that although some of the tools are described as wizards, the tools may be implemented in other forms as desired, such as, for example, APIs, integrated GUIs, and so forth. It should be further noted that the tools described below are intended to be exemplary only, and are not intended to limit the tools to any particular set or organization of functionalities.

FIG. 17—Elemental I/O Nodes

In a preferred embodiment, elemental I/O nodes represent I/O pointers that are bound at edit time to specific target resources. In one embodiment, the following types may be supported: Analog Input, Analog Output, Digital Input, and Digital Output, among others.

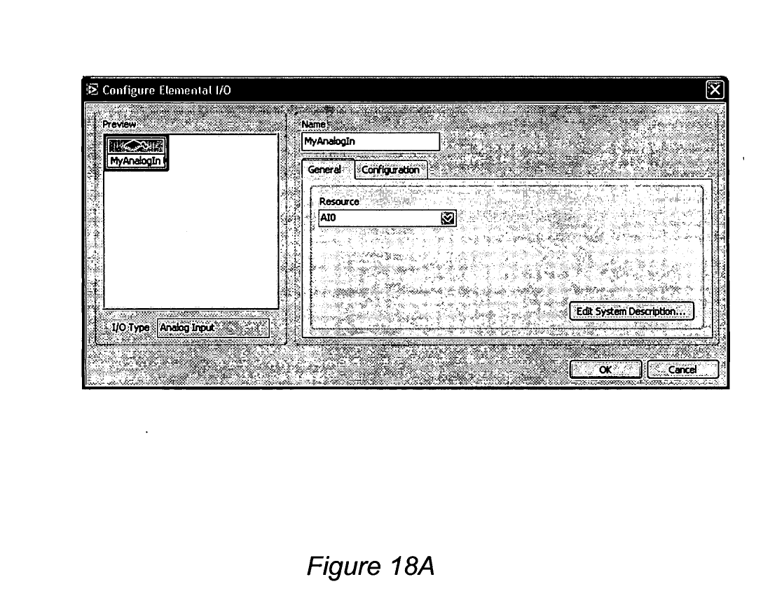

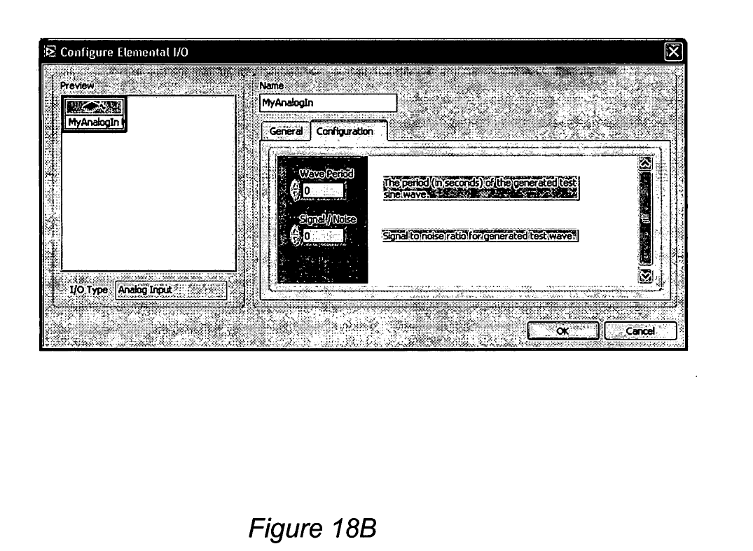

FIG. 17 illustrates an example graphical program or block diagram utilizing two types of elemental I/O nodes, according to one embodiment. As FIG. 17 shows, input nodes are included in the graphical program for acquiring temperature data and for a power on signal, where the temperature data is analog data, and the power on signal is digital data. Similarly, respective output nodes are included for motor speed (analog) and for a start signal (digital). Thus, elemental I/O nodes are provided for both analog and digital data. Note that in this embodiment, the names of the I/O nodes indicate aliases to which the nodes point, e.g., the “Temperature” node for example points to an alias called “Temperature”, which may be defined in the project, e.g., in the embedded project. The aliases may point to or be associated with target I/O resources whose names may not be visible on the block diagram. In one embodiment, in order to see or access the target I/O resource name, the user may double click on the elemental I/O node (see FIGS. 18A and 18B), or, alternatively, may access the resource name via a tool, such as an alias manager, one embodiment of which is described below with reference to FIGS. 23A and 23B.

As FIG. 17 also shows, in one embodiment, the elemental I/O nodes may be selectable from a palette. In this example, a palette of nodes for elemental digital output is shown from which a user may select the nodes for inclusion in a graphical program, e.g., by dragging and dropping the node onto the block diagram.

In one embodiment, once an I/O node has been included in the graphical program, the user may configure the node. For example, in one embodiment, the user may right click on a node to invoke display of configuration options, such as, for example, “bind to resource” and “show implementation” (or equivalents), among others. Selection of the first option may invoke or launch a binding tool, described below, while selection of the second option may invoke display of graphical program code scripted underneath the elemental I/O node (which may be useful for debugging).

Note that the information used by these nodes to script code is preferably supplied either statically or at edit time. For example, static code scripted in the block diagram may be supplied by a plugin for a particular I/O resource. New plugins may be developed using a plugin wizard or equivalent, described below. Information passed at edit time may be supplied by the user via one or more configuration dialogs (or equivalent) and scripted as appropriate constants along with the static code.

In one embodiment, another tool may be provided for managing user parameters and binding elemental I/O nodes, such as, for example, an embedded project manager (or functional equivalent), which may be more suited for multi-target applications, i.e., where one set of nodes must be operable to execute on selected targets without modifying the block diagram.

FIGS. 18A-18B—Configuration Dialog

One embodiment of a configuration dialog for elemental I/O is now described. In one embodiment, the configuration dialog may comprise a dialog box utility that pops up when the user double clicks on an elemental I/O node. The configuration dialog may allow binding of elemental I/O nodes to new or existing aliases, which, as described above, may point to I/O resources on the current target. In one embodiment, the binding may be defined by a file, for example, created by a tool, e.g., a property builder utility, and exported by the embedded project manager. The configuration dialog is preferably tightly integrated with the embedded project and supports basic functionality such as: binding elemental I/O nodes to aliases, which point to specific I/O resources on a current target; creating new aliases, and editing static properties for current I/O resources, among others.

FIGS. 18A-18B illustrate exemplary panels of the configuration dialog, according to one embodiment. Note that the configuration tool illustrated in FIGS. 18A-18B is meant to be illustrative only, and is not intended to limit the tool to any particular form, function, or appearance. For example, rather than being implemented as a dialog, the binding tool may be integrated into the development environment, or implemented as an API, wizard, etc.

Upon invocation of the configuration dialog, a first panel or dialog may be presented to the user for selecting among various general options (e.g., in or under a ‘general’ tab). As FIG. 18A shows, this first tab may include a resource selection box to specify the target I/O resource that the alias (indicated above the tabs) will point to.

In this embodiment, a name control indicates the alias name. Typing in a new name may invoke creation of a new alias, while typing in an existing alias name may allow configuration of the existing alias.

If the user switches to the configuration tab shown in FIG. 18B, a set of target specific configuration options may appear. In one embodiment, these options may be changed at edit time only and may affect the behavior of the target I/O resource.

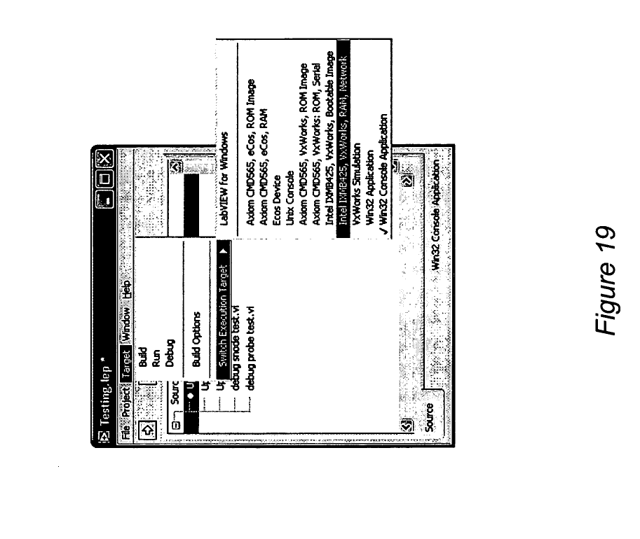

FIG. 19—Embedded Project Manager

In one embodiment, executing a program or VI on different targets may utilize a repository of configuration files for supported targets. In one embodiment, a utility may be provided that allows the user to easily switch between targets. For example, in one embodiment, an embedded project manager utility (or equivalent) may be provided that may be operable to run in the background and that may perform one or more of the following functions:

Creating new target instantiations: In one embodiment, the embedded project manager may facilitate mapping physical I/O resources, e.g., channels, of a new target platform, e.g., an FPGA-based device or embedded processor, with corresponding software structures, e.g., software I/O channels used by elemental I/O nodes. For example, a user may provide a characterization of a new hardware platform, including, for example, processor information, I/O lines or pins, and so forth, referred to as resource definitions. The embedded project manager may then determine whether and/or how a program's I/O nodes may utilize the I/O resources, and, if possible, mapping the program's I/O channels to the physical I/O channels of the target device.

Switching targets: In one embodiment, the embedded project manager may be operable to rebind the elemental I/O nodes on the block diagram within the current embedded project to new target resource definitions with the same names. In other words, the embedded project manager may “switch out” the hardware while retaining the elemental I/O nodes that communicate with the hardware.

Viewing and editing of static properties of I/O resources for particular targets: In one embodiment, the embedded project manager may allow the user to view and edit the properties of I/O lines or channels for specified target platforms using the alias manager utility (see FIG. 23, described below).

Managing files: In one embodiment, the embedded project manager may provide standard file management operations, such as open, save, and edit.

Managing VIs: In one embodiment, the embedded project manager may provide program management operations for programs (VIs) that are part of the project, such as, for example adding and deleting VIs to and from the project.

Debugging: In one embodiment, the embedded project manager may be operable to keep track of nodes on the diagram and where they are bound, i.e., may provide information as to which hardware resources are bound to each node.

FIG. 19 illustrates one embodiment of a GUI for the embedded project manager. In the example shown, the user is switching between already created targets, specifically, “Axiom CMD565, eCOS, ROM Image”, “Intel IXMB425, VxWorks, RAM, Network”, “VxWorks Simulation” and others. In a preferred embodiment, when the user switches targets, all elemental I/O nodes in the graphical program, i.e., on the block diagrams, within the project may be rebound to I/O resources defined for the new target. In one embodiment, this re-mapping is performed by matching alias names. For example, an alias called Temperature in target “Axiom CMD565, eCOS, ROM Image” is bound to an I/O resource AI0. When the target is switched to “VxWorks Simulation” the alias called Temperature will point to a different I/O resource SimAI0. Name mismatches may break the binding. It should be noted that in other embodiments, other matching criteria besides names may be used.

When support for new targets is desired, such as when a user specifies a new target platform or target class, some target-specific code and information may be required, e.g., and so may be provided by the user for use by the embedded project manager. For example, in one embodiment, the user may provide implementation VIs for elemental I/O nodes and static properties for elemental I/O types with their default values. The implementation VIs may comprise code that is written or scripted to a graphical program or block diagram when the elemental I/O nodes in the program are bound to the I/O resources of the target device. In one embodiment, the VIs and information may be provided in the form of plugins for the embedded project manager. In other words, a plugin may be provided by the user for each new target to be supported by the elemental I/O nodes.

In one embodiment, a tool, e.g., a wizard, may be provided to users to facilitate creation of the plugins for supporting elemental I/O node functionality for new targets, e.g., for user-defined or specified targets.

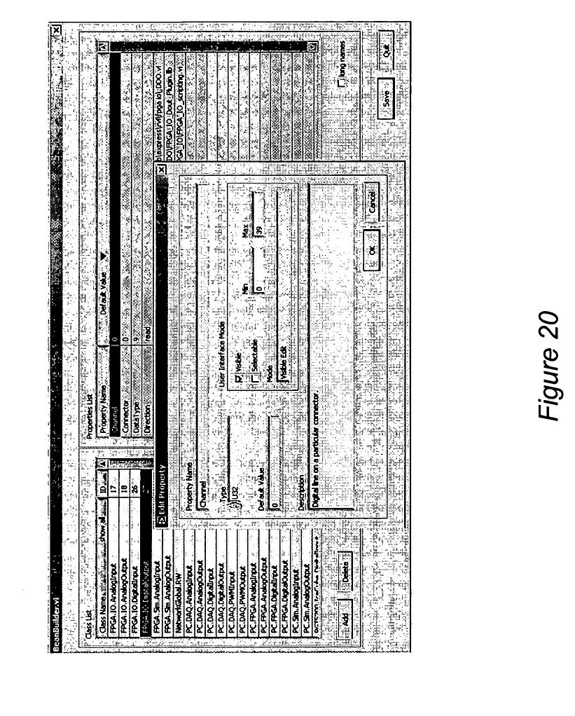

FIG. 20—Property Builder Utility

In one embodiment, a property builder may be provided for development purposes, where the property builder allows a developer to define all properties relevant to I/O resources. For example, the property builder may support creating, modifying, and deleting I/O resources and targets, and may be operable to build a single file, referred to as a variant file, that contains all parameters that are part of a workspace.

FIG. 20 illustrates one embodiment of a property builder utility being used to edit a channel property of target class FPGA.IO.DigitalOutput. Note that in this example, targets are organized with a dot notation in the following order: Execution_Platform.IO_resource.IO_Flavor, where “execution_Platform” refers to the top-level hardware device, “IO_resource” refers to the relevant component of the device, and “flavor” refers to the particular type of I/O line or channel.

As FIG. 20 shows, once the target class list is selected (shown in the left-most window of the GUI), a properties list window (shown in the right side of the GUI) may present the various properties (and corresponding default values) of the selected target (class), e.g., channel, connector, data type, and so forth. The user may then select a property from the properties list, invoking an edit dialog whereby the property may be edited. In the example shown, the edit dialog includes fields for property name, data type, and default value, as well as a section for specifying a user interface mode for the property, such as, for example, whether the property is visible and/or editable, and what its minimum and maximum values are. As also shown, a field is provided for displaying a text description of the property.

Thus, the property builder utility (or equivalent) may allow the user to view and edit the I/O resource properties of the target.

Thus, in one embodiment, elemental I/O nodes may be extendible to multiple targets that support statically configured single point I/O. The elemental I/O nodes and related functionality (e.g., tools) may provide a framework for creating a new target and mapping a set of I/O resources from one target to another, e.g., using the embedded project manager utility.

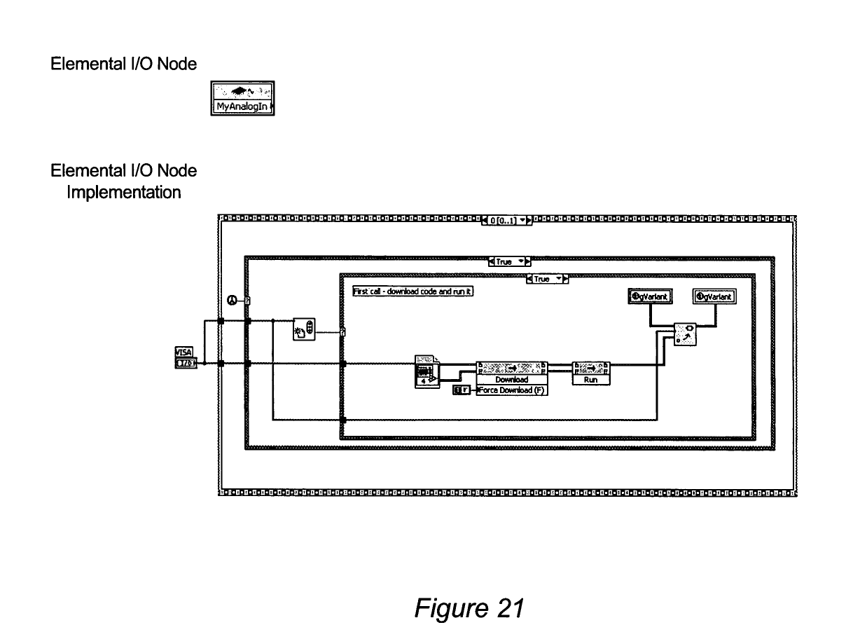

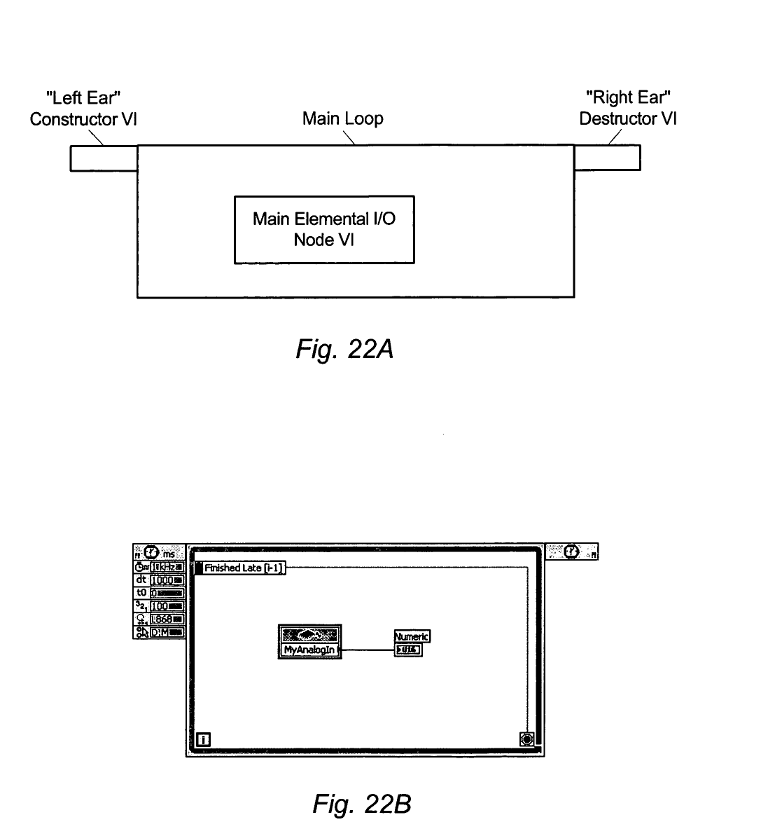

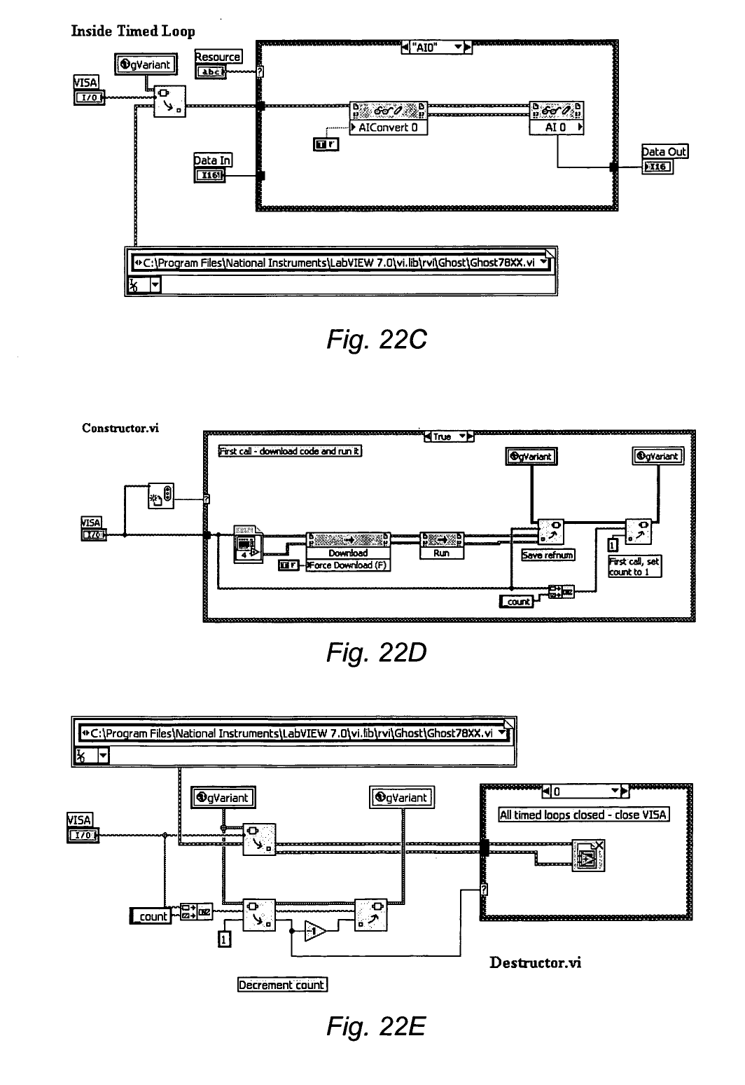

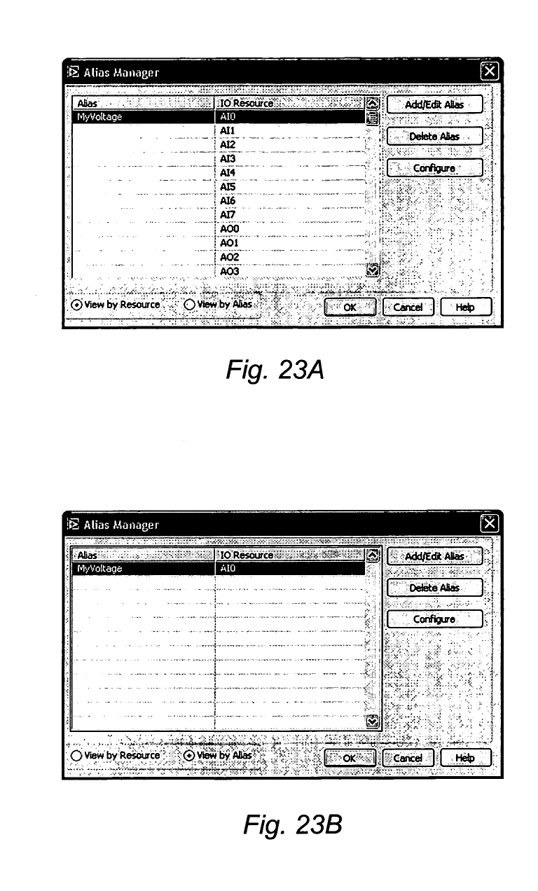

FIGS. 21-22E—Examples of Elemental I/O Nodes and Implementations

FIGS. 21-22E illustrate exemplary implementations of the elemental I/O node based on different program contexts. Although the example programs are LabVIEW graphical programs (block diagrams), it should be noted that any other types of graphical program may be used.

FIG. 21 illustrates an exemplary implementation of an elemental I/O node in a typical graphical program, such as the graphical program of FIG. 17, according to one embodiment. In this example, an embodiment of an analog input node is shown, as well as an implementation VI for the analog input node for an FPGA target. When the input node executes for the first time, the implementation code may operate to download an application to an FPGA using a host interface mechanism. Thus, the elemental I/O node may generate specific implementation code based on the specified target.

In one embodiment, an elemental I/O node may generate different implementation code based not only on the target, but also on the location of the node in a graphical program. For example, some graphical programs may include a structure called a timed loop, where the time allowed or specified for each iteration of the loop is strictly controlled, e.g., for time-critical applications. In one embodiment, the elemental I/O node may generate different code from that of FIG. 21 if the node is placed inside a timed loop, described below with reference to FIGS. 22A-22E. Specifically, if the elemental I/O node is dropped inside the timed loop structure, the node may script constructor and destructor VIs before and after the timed loop.

FIGS. 22A-22E illustrate an implementation of the analog input node of FIG. 21 in the context of a timed loop. FIG. 22A is a simplified diagram illustrating a timed loop and a three-part implementation of the node, e.g., three VIs, according to one embodiment. As FIG. 22A shows, in this embodiment, a main elemental I/O node VI may be included inside the timed loop, while constructor and destructor VIs for the node may be outside the loop, or more specifically, may be “attached” to the loop on the left and right sides, respectively, referred to as the “left ear” and “right ear” of the loop. The constructor may operate to perform initialization functions for the target device, while the destructor may operate to perform cleanup operations, e.g., clearing resources related to the device once the specified task is complete. The main elemental I/O node VI provides the primary functionality of the I/O node. Thus, the portions of the node functionality that are only performed once, and that should not be included in the “timed” part of the program are separated from the portion that is performed iteratively under time constraints.

FIG. 22B illustrates a block diagram or graphical program showing the timed loop and VIs of FIG. 22A, where the original node has been recast into three nodes—a constructor node, a destructor node, and the main (modified) analog I/O node.

In one embodiment, when the elemental I/O node “MyAnalogIn” is dropped into the timed loop structure, it recognizes its special location and signals the timed loop to script two VIs before and after the loop (left and right ear). This allows the loop to start running deterministically right from the start. Time consuming initialization (e.g., opening a VISA session) may be completing in the left ear prior to the start of the timed loop. The destructor in the right ear may close the resource (e.g., close the VISA session). The VI scripted into the timed loop may also be different. For example, open/close VISA session operations may be replaced with reading global variables containing references to those sessions. FIGS. 22C-22E, described below, illustrate the underlying code of the VIs or nodes.

FIG. 22C illustrates one embodiment of underlying code for the main analog I/O node of FIG. 22B. As FIG. 22C shows, in this example, the elemental I/O node may script code that does not download an application to FPGA, but instead reads a reference to that (application) code from a global variable, gVariant. When the main analog I/O node or VI executes, the application has preferably already been downloaded using the constructor VI in the left ear of the timed loop (see FIG. 22D, described below). Thus, the main analog I/O VI just performs analog input functionality in an iterative manner under the time constraints of the timed loop, i.e., receiving or acquiring input data from the specified I/O resource of the target device, and outputting the data to a specified destination, e.g., for storage on a computer.

FIG. 22D illustrates one embodiment of underlying code for the constructor VI of FIG. 22B. As shown, in this example, the constructor VI operates to initiate a VISA session, downloads an application to the FPGA, runs the application, and stores a reference to the application in the global variable, gVariant, for access by the main analog I/O VI of FIG. 22D. Thus, the constructor VI may perform the initial (and time-consuming) tasks required for analog data acquisition from the target, freeing the main analog I/O VI to perform the actual I/O operations under the time constraints of the timed loop.

FIG. 22E illustrates one embodiment of underlying code for the destructor VI of FIG. 22B. As FIG. 22E shows, the destructor VI may operate to perform cleanup operations for the analog I/O task, i.e., closing the VISA session. Note that the destructor operates in the “right ear” of the timed loop, and so conducts its operations outside the iterative processing of the loop.

Thus, in some embodiments, the elemental I/O nodes may generate different underlying code based not only on the specified target platform, but also on the particular context of the node in the graphical program, i.e., on the node's location in the graphical program.

FIGS. 23A and 23B—Alias Manager

An alias manager is a tool that allows easy user interaction with aliases and IO resources, i.e., for managing aliases, described above with reference to FIGS. 17-19. FIGS. 23A and 23B illustrate one embodiment of an alias manager. In this embodiment, respective columns for aliases and IO resources are displayed in a panel or dialog, namely, an alias column that lists user defined aliases that can be used in the current project, and an I/O resource column that lists all I/O resources available on the current target. In a preferred embodiment, the I/O resource list may be specific to targets and thus may change when the target changes. In one embodiment, the alias manager may update the IO resource list whenever it is opened (or reopened).

In the embodiment shown, the user may add and delete aliases via buttons shown on the right side of the panel. Radio buttons in the lower left corner switch how data are presented to the user. For example, when the “View by Resource” radio button is selected, as shown in FIG. 23A, data are organized according to the IO resource column. In this view all resources are visible on the right. Alternatively, when the “View by Alias” radio button is selected, as shown in FIG. 23B, the data are organized in accordance with the alias column. In this view all aliases are visible on the left and their corresponding IO resources are shown on the right. This view is referred to as a compact view because in general not all IO resources have a corresponding alias associated with them.

Another Implementation of Programmatic Generation

The above-discussed examples of programmatically generating a graphical program or graphical program portion may be implemented in any of various ways. For more information on one embodiment of a system and method for programmatically generating a graphical program, please refer to the above-incorporated patent application titled, “System and Method for Programmatically Generating a Graphical Program in Response to Program Information”.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

Although the system and method of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

1. A carrier medium for programmatically generating a graphical program, the carrier medium comprising program instructions executable to perform:
receiving input specifying desired functionality of the graphical program;
receiving input indicating a target platform for the graphical program; and
programmatically generating the graphical program in response to the input specifying the functionality of the graphical program, wherein the graphical program substantially implements the specified functionality, and wherein the graphical program is programmatically generated based on the target platform for the graphical program.

2. The carrier medium of claim 1,
wherein the target platform for the graphical program is a first target platform of a plurality of possible target platforms; and
wherein the graphical program is programmatically generated based on the first target platform.

3. The carrier medium of claim 1,
wherein the target platform for the graphical program is a first type of a plurality of possible target platform types; and
wherein the graphical program is programmatically generated based on the first type of target platform.

4. The carrier medium of claim 1,
wherein said programmatically generating is operable to generate different implementations of the graphical program for different target platforms.

5. The carrier medium of claim 4,
wherein said programmatically generating is operable to generate different graphical programs for different target platforms.

6. The carrier medium of claim 1,
wherein said programmatically generating is operable to generate a first implementation of the graphical program which includes pipelining of nodes for a first type of target platform.

7. The carrier medium of claim 1,
wherein the graphical program comprises a plurality of interconnected nodes that visually indicate functionality of the graphical program.

8. The carrier medium of claim 7,
wherein said programmatically generating is operable to generate different implementations of the graphical program for different target platforms; and
wherein the different implementations of the graphical program comprise one or more of: 1) different types of nodes in the graphical program; and 2) different interconnections of the nodes in the graphical program.

9. The carrier medium of claim 1, wherein said receiving input specifying desired functionality of the graphical program comprises:
receiving user input specifying desired functionality of the graphical program.

10. The carrier medium of claim 1, wherein said receiving input indicating a target platform for the graphical program comprises:
receiving user input indicating the target platform for the graphical program.

11. The carrier medium of claim 1, wherein said receiving input indicating a target platform for the graphical program comprises:
receiving the input indicating the target platform for the graphical program via a discovery process, wherein the discovery process operates to identify the target platform.

12. The carrier medium of claim 11, wherein the discovery process further operates to characterize the target platform.

13. The carrier medium of claim 12, wherein the discovery process further operates to characterize the target platform by one or more of:
querying the target device; and
querying a database based on the target platform identity.

14. The carrier medium of claim 1,
wherein the graphical program comprises a block diagram and a user interface, wherein the block diagram comprising a plurality of interconnected nodes which visually indicate functionality of the graphical program, wherein the user interface comprises one or more graphical user interface elements for enabling user interaction with the graphical program; and
wherein said programmatically generating the graphical program includes generating the block diagram portion and the user interface portion.

15. The carrier medium of claim 14,
wherein said programmatically generating is operable to generate different implementations of the block diagram for different target platforms.

16. The carrier medium of claim 15,
wherein the different implementations of the block diagram comprise one or more of: 1) different types of nodes in the block diagram; and 2) different interconnections of the nodes in the block diagram.

17. The carrier medium of claim 14,
wherein said programmatically generating is operable to generate different implementations of the user interface for different target platforms.

18. The carrier medium of claim 14,
wherein said programmatically generating is operable to generate a first implementation of the graphical program which includes no user interface for the graphical program for a first type of target platform.

19. The carrier medium of claim 14,
wherein said programmatically generating is operable to generate a first implementation of the graphical program which includes a reduced user interface for the graphical program for a first type of target platform.

20. The carrier medium of claim 14,
wherein said programmatically generating is operable to generate an implementation of the graphical program which includes an enhanced user interface for the graphical program for a first type of target platform.

21. The carrier medium of claim 14,
wherein said programmatically generating is operable to generate a first implementation of the graphical program which includes no interface for the graphical program for a first type of target platform; and
wherein said programmatically generating is operable to generate a second implementation of the graphical program which includes a user interface for the graphical program for a second type of target platform.

22. The carrier medium of claim 14,
wherein said programmatically generating is operable to generate a first implementation of the graphical program which includes a reduced user interface for the graphical program for a first type of target platform; and
wherein said programmatically generating is operable to generate a second implementation of the graphical program which includes an enhanced user interface for the graphical program for a second type of target platform.

23. The carrier medium of claim 1,
wherein said input indicates that the target platform for the graphical program is a programmable hardware element; and
wherein said programmatically generating programmatically generates an implementation of the graphical program at least partly optimized for execution in the programmable hardware element.

24. The carrier medium of claim 1,
wherein said input indicates that the target platform for the graphical program is a processor executing a real time operating system; and
wherein said programmatically generating programmatically generates the graphical program at least partly optimized for execution by the processor executing the real time operating system.

25. The carrier medium of claim 1,
wherein said input indicates that the target platform for the graphical program is a general purpose computer system; and
wherein said programmatically generating programmatically generates the graphical program at least partly optimized for execution by the general purpose computer system.

26. The carrier medium of claim 1,
wherein said input indicates that the target platform for the graphical program is a grid computer comprising a plurality of networked computer systems; and
wherein said programmatically generating programmatically generates the graphical program at least partly optimized for execution by the grid computer in a distributed manner.

27. The carrier medium of claim 1,
wherein said input indicates that the target platform for the graphical program is a person digital assistant (PDA); and
wherein said programmatically generating programmatically generates the graphical program at least partly optimized for execution by the PDA.

28. The carrier medium of claim 1,
wherein said input indicates that the target platform for the graphical program is an embedded device with no inherent user interface capability; and
wherein said programmatically generating comprises programmatically generating the graphical program having a block diagram implementation for execution on the embedded device.

29. The carrier medium of claim 1,
wherein said input indicates that the target platform for the graphical program is an embedded device with no inherent user interface capability; and
wherein said programmatically generating comprises programmatically generating the graphical program having a block diagram implementation for execution on the embedded device and a user interface implementation for execution by a computer system including a display device, wherein the block diagram implementation executing on the embedded device is operable to communicate with the user interface implementation executing on the computer system.

30. The carrier medium of claim 1, wherein said programmatically generating comprises programmatically generating the graphical program at least partly optimized with respect to one or more of:
size of the graphical program;
speed of execution of the graphical program; and
parallelism of execution of the graphical program.

31. The carrier medium of claim 1,
wherein said functionality comprises measurement functionality;
wherein said input indicates that the target platform for the graphical program is a measurement device;
wherein said programmatically generating comprises programmatically generating the graphical program for execution on the measurement device; and
wherein said programmatically generating comprises programmatically generating the graphical program at least partly optimized with respect to one or more of:
a sample rate of the measurement device;
timing attributes of the measurement device;
display capabilities of the measurement device;
on-board signal processing resources of the measurement device; and
number of channels supported by the measurement device.

32. The carrier medium of claim 1,
wherein said programmatically generating the graphical program comprises programmatically generating a portion of a graphical program.

33. The carrier medium of claim 1,
wherein said receiving input indicating a target platform for the graphical program comprises:
receiving input indicating a plurality of target platforms for the graphical program, wherein the plurality of target platforms are indicated to conjunctively perform the functionality of the graphical program;
wherein said programmatically generating the graphical program comprises:
programmatically generating a corresponding plurality of portions of the graphical program for respective execution on the plurality of target devices.

34. The carrier medium of claim 1,
wherein said programmatically generating the graphical program creates the graphical program without any user input specifying the graphical program during said programmatically generating.

35. The carrier medium of claim 1, wherein said programmatically generating the graphical program comprises:
creating a plurality of graphical program objects in the graphical program; and
interconnecting the plurality of graphical program objects in the graphical program;
wherein the interconnected plurality of graphical program objects comprise at least a portion of the graphical program.

36. The carrier medium of claim 1, wherein said programmatically generating the graphical program comprises:
creating one or more user interface objects in the graphical program, wherein the one or more user interface objects perform one or more of providing input to or displaying output from the graphical program.

37. The carrier medium of claim 1,
wherein the input received specifies an instrumentation function; and
wherein the programmatically generated graphical program implements the specified instrumentation function.

38. The carrier medium of claim 1,
wherein said programmatically generating the graphical program comprises calling an application programming interface (API) enabling the programmatic generation of a graphical program.

39. The carrier medium of claim 1,
wherein said programmatically generating the graphical program comprises programmatically requesting a server program to generate the graphical program.

40. The carrier medium of claim 1,
wherein said receiving user input indicating a target platform for the graphical program further comprises:
receiving user input indicating I/O (input/output) resources for the target platform; and
wherein said programmatically generating the graphical program comprises:
generating graphical program code for one or more I/O nodes in the graphical program based on the indicated I/O resources.

41. The carrier medium of claim 40,
wherein said programmatically generating the graphical program comprises:
one or more I/O nodes in the graphical program generating respective graphical program code for themselves based on the indicated I/O resources.

42. The carrier medium of claim 1,
wherein the program instructions further implement a graphical user interface (GUI), wherein the GUI operates to perform said receiving input specifying desired functionality of the graphical program and said receiving input indicating a target platform for the graphical program.

43. The carrier medium of claim 1, wherein said programmatically generating the graphical program comprises:
analyzing a program context of a node in the graphical program; and
programmatically generating at least a portion of the graphical program based on said analyzing.

44. A method for programmatically generating a graphical program, the method comprising:
receiving input specifying desired functionality of the graphical program;
receiving input indicating a target platform for the graphical program; and
programmatically generating the graphical program in response to the input specifying the functionality of the graphical program, wherein the graphical program substantially implements the specified functionality, and wherein the graphical program is programmatically generated based on the target platform for the graphical program.

45. A system for programmatically generating a graphical program, the system comprising:
a processor;
a input device for:
receiving input specifying desired functionality of the graphical program; and
receiving input indicating a target platform for the graphical program; and
a memory medium coupled to the processor, wherein the memory medium stores a graphical program generation program for programmatically generating the graphical program in response to the input specifying the functionality of the graphical program, wherein the graphical program substantially implements the specified functionality, wherein the graphical program is programmatically generated based on the target platform for the graphical program.

46. The system of claim 45, further comprising:
a display device coupled to the processor;
wherein the graphical program generation program is operable to display a graphical user interface (GUI) on the display device, and wherein the GUI is operable to receive user input specifying desired functionality of the graphical program, and user input indicating a target platform for the graphical program

47. A system for programmatically generating a graphical program, the system comprising:
means for receiving input specifying desired functionality of the graphical program;
means for receiving input indicating a target platform for the graphical program; and
means for programmatically generating the graphical program in response to the input specifying the functionality of the graphical program, wherein the graphical program substantially implements the specified functionality, and wherein the graphical program is programmatically generated based on the indicated target platform for the graphical program.

48. A carrier medium for programmatically generating a graphical program, the carrier medium comprising program instructions executable to perform:
receiving input specifying desired functionality of the graphical program;
receiving input indicating a target platform for the graphical program; and
programmatically generating an implementation of the graphical program in response to the input specifying the functionality of the graphical program, wherein the implementation of the graphical program performs the specified functionality;
wherein said programmatically generating generates the implementation of the graphical program based on the indicated target platform for the graphical program; and
wherein said programmatically generating is operable to generate different implementations of the graphical program for different target platforms.

49. A carrier medium for programmatically generating a graphical program, the carrier medium comprising program instructions executable to perform:
storing program information specifying desired functionality of the graphical program;
receiving first input indicating a first target platform for the graphical program; and
programmatically generating a first implementation of the graphical program in response to the program information and the first input, wherein the graphical program substantially implements the specified functionality, and wherein the first implementation of the graphical program is programmatically generated based on the first target platform for the graphical program.

50. The carrier medium of claim 49, wherein the program instructions are further executable to perform:
receiving second input indicating a second target platform for the graphical program; and
programmatically generating a second implementation of the graphical program in response to the program information and the second input, wherein the graphical program substantially implements the specified functionality, and wherein the second implementation of the graphical program is programmatically generated based on the second target platform for the graphical program.
